(19) United States
(12) Patent Application Publication
(10) Pub. No.: US 2025/0289370 A1
(43) Pub. Date: Sep. 18, 2025

(54) DEPTH-BASED VEHICLE ENVIRONMENT VISUALIZATION USING GENERATIVE AI

(71) Applicant: NVIDIA CORPORATION, Santa Clara, CA (US)

(72) Inventors: Abhishek Haridas BADKI, Santa Clara, CA (US); Hang SU, Cambridge, MA (US); Jan KAUTZ, Lexington, MA (US); Orazio GALLO, Santa Cruz, CA (US)

(21) Appl. No.: 18/670,373

(22) Filed: May 21, 2024

Related U.S. Application Data
(60) Provisional application No. 63/566,129, filed on Mar. 15, 2024.
(60) Provisional application No. 63/565,885, filed on Mar. 15, 2024.

(51) Int. Cl. B60R 1/27; G06T 5/70; G06T 7/593; G06T 17/00; G06T 19/20

(52) U.S. Cl. CPC B60R 1/27; G06T 5/70; G06T 7/593; G06T 17/00; G06T 19/20; G06T 2207/10028

(57) ABSTRACT

In various examples, systems and methods are disclosed relating to geometry estimation and dynamic object rendering for vehicle environment visualization. In embodiments, the environment surrounding an ego-machine may be visualized by extracting one or more depth maps from image data, converting the depth map(s) into a 3D surface topology of the surrounding environment, and/or texturizing the detected 3D surface topology with image data. Dynamic objects such as moving vehicles or pedestrians may be detected and masked from a first pass of texturization. Rigid dynamic objects may be visualized by warping corresponding depth values using corresponding trajectories, inserting or fusing the resulting warped 3D representation of each such object into the (e.g., texturized) 3D surface topology, and texturizing the warped 3D representation of each object using corresponding image data. Non-rigid dynamic objects may be represented as flat 2D surfaces and texturized with corresponding image data.

### CROSS-REFERENCE TO RELATED APPLICATIONS

This application claims the benefit of U.S. Provisional Application No. 63/566,129 filed on Mar. 15, 2024, and U.S. Provisional Application No. 63/565,885 which was filed on Mar. 15, 2024. The contents of each of the foregoing applications are incorporated by reference in their entirety.

### BACKGROUND

Vehicle Surround View Systems provide occupants of a vehicle with a visualization of the area surrounding the vehicle. Surround View Systems provide the driver with the ability to see the vicinity of the environment, including blind spots where the driver's line of sight is occluded by parts of the driver's vehicle or other objects in the environment, without the need to reposition (e.g., turn their head, get off the driver's seat, lean a certain direction, etc.). This visualization may assist and facilitate a variety of driving maneuvers, such as smoothly entering or exiting a parking spot without colliding with vulnerable road users—like pedestrians—or objects—such as a road curb or other vehicles. More and more vehicles, especially those of luxury brands or newer models, are being produced with Surround View Systems equipped. The Surround View Systems of existing vehicles usually utilize fisheye cameras-typically mounted at the front, left, rear and right sides of the vehicle body—to perceive the surrounding area from multiple directions. In some techniques, frames from the individual cameras are stitched together using camera parameters to align frames and blending techniques to combine overlapping regions to provide a top-down 360° surround view visualization.

However, existing techniques to generate visualizations of a surrounding environment have a variety of drawbacks. For example, in some existing Surround View Systems, two-dimensional (2D) images are used to approximate a three-dimensional (3D) visual representation of the environment surrounding the vehicle by modeling the geometry of the environment surrounding the vehicle as a virtual 3D bowl shape. The 3D bowl shape typically comprises a flat, circular ground plane for the inner portion of the bowl connected to an outer bowl represented as a curved surface rising from the ground plane to a height or with a slope that increases proportionally to the distance from the bowl center. As such, some conventional systems project (e.g., stitched) images onto this 3D bowl shape, render a view of the projected image data on the 3D bowl shape from the perspective of a virtual camera, and present the rendered view on a monitor visible to occupants or an operator (e.g., driver) of the vehicle. However, the projection and/or stitching processes can introduce a variety of artifacts, including geometric distortions (e.g., size or shape misalignments), texture distortions (e.g., blur, ghosting, object disappearance, object distortions), and color distortions. Since these artifacts may obscure or omit useful visual information and are often distracting to the driver, the artifacts can interfere with the safe operation of the vehicle in certain scenarios. As a result, there is a need for improved visualization techniques that reduce visual artifacts, better represent useful visual information, and/or otherwise improve the visual quality of resulting images.

### SUMMARY

Embodiments of the present disclosure relate to geometry estimation and dynamic object rendering for vehicle environment visualization. In contrast to conventional systems, such as those described above, the environment surrounding an ego-machine may be visualized by texturizing a detected 3D surface topology of the surrounding environment, and dynamic objects may be rendered by texturizing warped 3D representations of rigid objects and/or flat 2D surfaces representing non-rigid objects.

In embodiments, the environment surrounding an ego-machine may be visualized by extracting one or more depth maps from image data, converting the depth map(s) into a detected 3D surface topology of the surrounding environment, and/or texturizing the detected 3D surface topology with image data. For example, one or more sensors (e.g., cameras) of an ego-machine—such as a vehicle—may be used to generate frames of sensor data (e.g., images) while the ego-machine navigates an environment. In an example implementation, multiple frames generated using different sensors (e.g., cameras) and representing the same time slice may be grouped together to represent spatial context, multiple frames generated using the same sensor (e.g., camera) and representing different time slices may be grouped together to represent temporal context, and the resulting (e.g., stacked) representation of the image data may be applied to the neural network(s) to estimate one or more depth maps (a depth map corresponding to each frame of image data). The one or more depth maps may be converted into a 3D representation of the detected surface topology of the surrounding environment. For example, the geometry of the surrounding environment may be modeled as a 3D surface using a (e.g., truncated) signed distance function (SDF) that encodes the distance of each voxel in a 3D grid to the detected 3D surface topology represented by the one or more depth maps. The sensor data may be back-projected onto the 3D surface representing the detected 3D surface topology using corresponding depth values in each back-projection to generate a texturized 3D surface, and a view of the texturized 3D surface may be generated from the perspective of a virtual camera.

Dynamic objects such as moving vehicles or pedestrians may be detected and masked from a first pass of texturization. Rigid dynamic objects may be visualized by warping corresponding depth values using corresponding trajectories, inserting or fusing the resulting warped 3D representation of each such object into the (e.g., texturized) 3D surface topology, and texturizing the warped 3D representation of each object using corresponding image data. Non-rigid dynamic objects may be represented as flat 2D surfaces and texturized with corresponding image data. As such, the techniques described herein may be utilized to visualize the environment surrounding an ego-machine more accurately than prior techniques. For example, estimating depth using multi-view cues and/or frames of sensor data representing different time slices provides a more accurate estimate of depth, and modeling the surrounding environment as a corresponding detected 3D surface topology provides a more accurate model of depth than prior techniques.

As such, the techniques described herein may be utilized to visualize the environment surrounding an ego-machine more accurately than prior techniques.

### BRIEF DESCRIPTION OF THE DRAWINGS

The present systems and methods for geometry estimation and dynamic object rendering for vehicle environment visualization are described in detail below with reference to the attached drawing figures, wherein:

FIG. 1 is a diagram illustrating an example environmental visualization pipeline, in accordance with some embodiments of the present disclosure;

FIG. 2 illustrates an example scenario in which depth may be estimated using frames of image data representing spatial and/or temporal context, in accordance with some embodiments of the present disclosure;

FIG. 3 illustrates an example 3D representation of a detected 3D surface topology, in accordance with some embodiments of the present disclosure;

FIG. 4 illustrates an example view of a detected 3D surface topology, in accordance with some embodiments of the present disclosure;

FIG. 5 is a flow diagram showing a method for generating a visualization of an environment using a signed distance field, in accordance with some embodiments of the present disclosure;

FIG. 6 is a flow diagram showing a method for generating a visualization of an environment based at least on a 3D surface topology of the environment, in accordance with some embodiments of the present disclosure;

FIG. 7 illustrates an example scenario in which dynamic objects may be detected using frames of image data, in accordance with some embodiments of the present disclosure;

FIGS. 8A-8B illustrate an example scenario in which a rigid dynamic object may be inserted into a 3D surface topology of an environment, in accordance with some embodiments of the present disclosure;

FIGS. 9A-9B illustrate an example scenario in which a set of non-rigid dynamic objects may be inserted in a 3D surface topology of an environment, in accordance with some embodiments of the present disclosure;

FIG. 10 is a flow diagram showing a method for generating a visualization of an environment with dynamic objects, in accordance with some embodiments of the present disclosure;

FIG. 11 is a flow diagram showing a method for generating a visualization of an environment based at least on generating graphical content for one or more 3D representations of one or more detected dynamic objects in accordance with some embodiments of the present disclosure;

FIG. 12A is an illustration of an example autonomous vehicle, in accordance with some embodiments of the present disclosure;

FIG. 12B is an example of camera locations and fields of view for the example autonomous vehicle of FIG. 12A, in accordance with some embodiments of the present disclosure;

FIG. 12C is a block diagram of an example system architecture for the example autonomous vehicle of FIG. 12A, in accordance with some embodiments of the present disclosure;

FIG. 12D is a system diagram for communication between cloud-based server(s) and the example autonomous vehicle of FIG. 12A, in accordance with some embodiments of the present disclosure;

FIG. 13 is a block diagram of an example computing device suitable for use in implementing some embodiments of the present disclosure; and

FIG. 14 is a block diagram of an example data center suitable for use in implementing some embodiments of the present disclosure.

### DETAILED DESCRIPTION

Systems and methods are disclosed relating to geometry estimation and dynamic object rendering for vehicle environment visualization. More specifically, the environment surrounding an ego-machine may be visualized by texturizing a detected 3D surface topology of the surrounding environment. Dynamic objects may be rendered by texturizing warped 3D representations of rigid objects and/or flat 2D surfaces representing non-rigid objects. The present techniques may be utilized to visualize an environment around an ego-machine, such as a vehicle, robot, and/or other type of object, in systems such as parking visualization systems, Surround View Systems, and/or others.

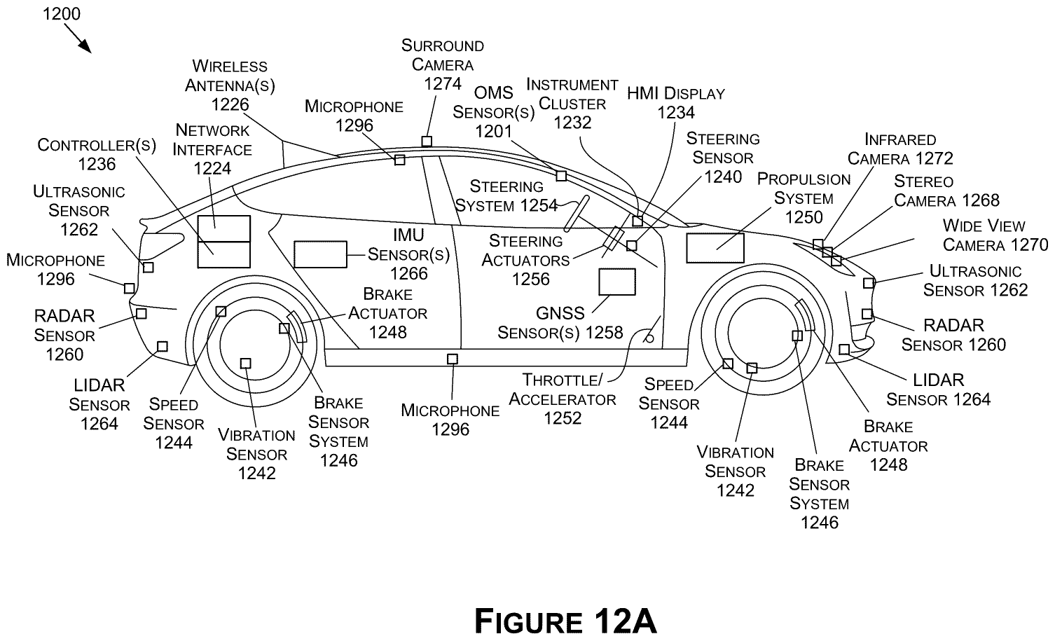

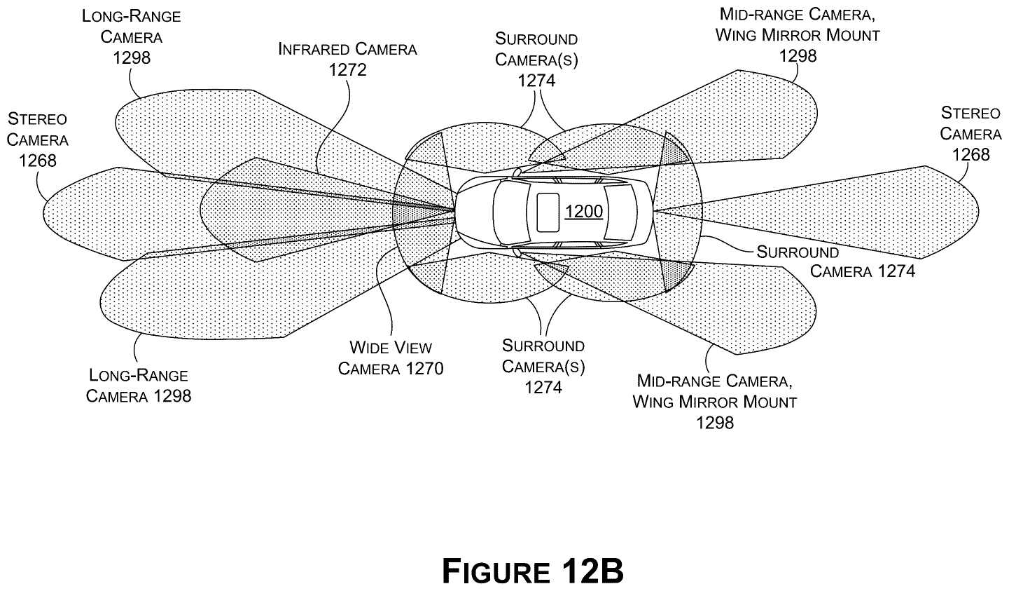

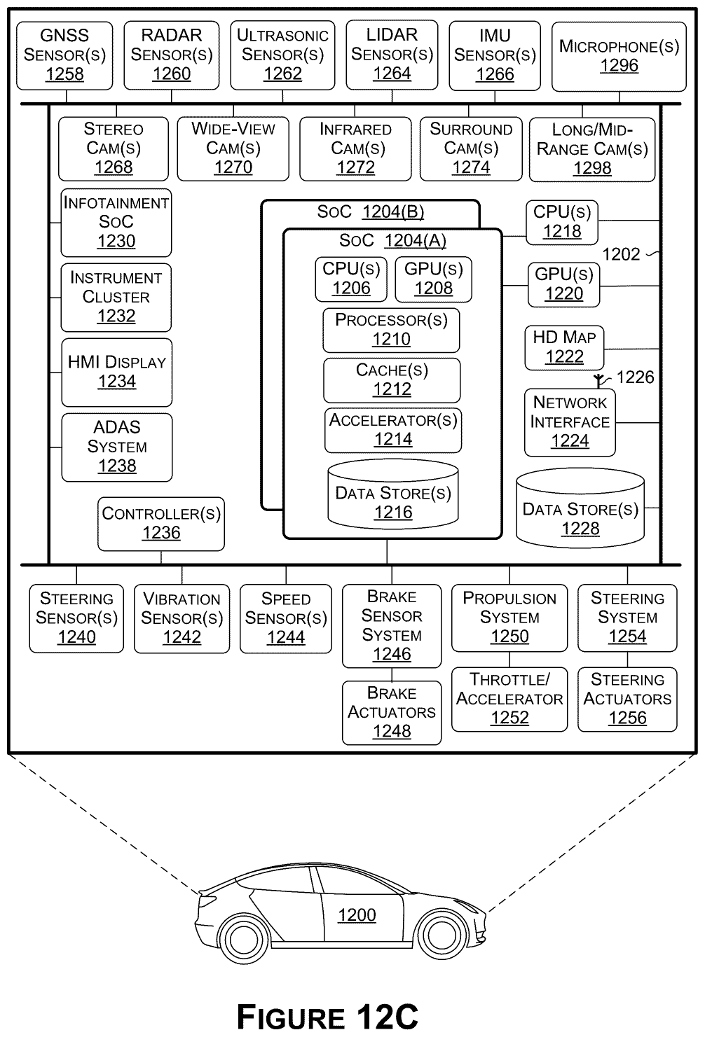

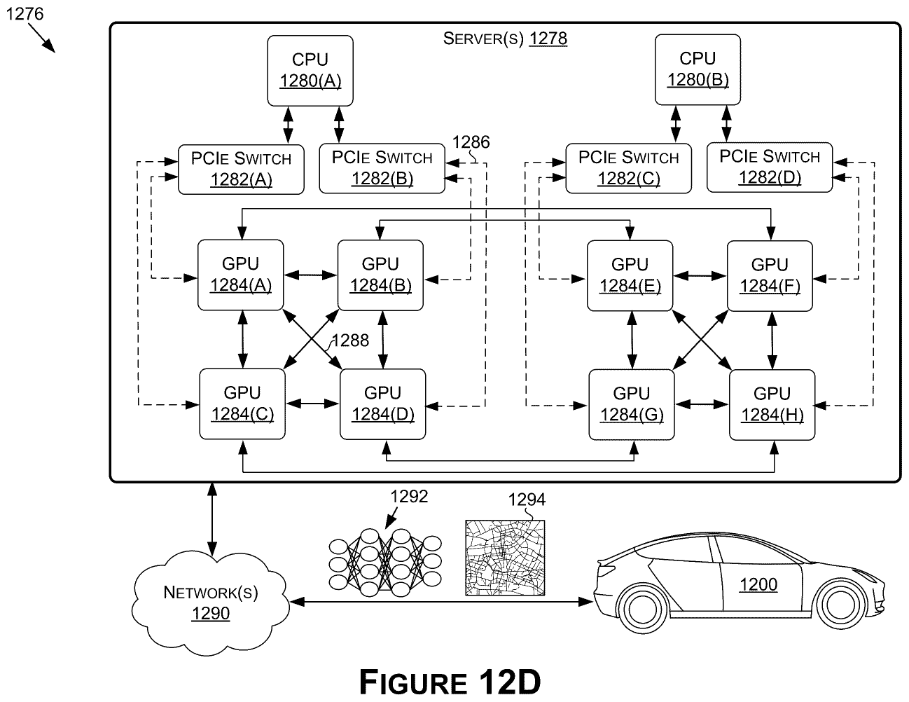

Although the present disclosure may be described with respect to an example autonomous or semi-autonomous vehicle or machine 1200 (alternatively referred to herein as “vehicle 1200” or “ego-machine 1200,” an example of which is described with respect to FIGS. 12A-12D), this is not intended to be limiting. For example, the systems and methods described herein may be used by, without limitation, non-autonomous vehicles or machines, semi-autonomous vehicles or machines (e.g., in one or more advanced driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. In addition, although the present disclosure may be described with respect to visualization of an environment surround an ego-machine, this is not intended to be limiting, and the systems and methods described herein may be used in augmented reality, virtual reality, mixed reality, robotics, security and surveillance, autonomous or semi-autonomous machine applications, and/or any other technology spaces where environment and/or dynamic object visualization may be used.

In some embodiments, the environment surrounding an ego-machine may be visualized by extracting one or more depth maps from image data, converting the depth map(s) into a detected 3D surface topology of the surrounding environment, and/or texturizing the detected 3D surface topology with the image data. Dynamic objects such as moving vehicles or pedestrians may be detected and masked from a first pass of texturization. Rigid objects may be visualized by warping corresponding depth values using corresponding trajectories, inserting or fusing the resulting warped 3D representation of each such object into the (e.g., texturized) 3D surface topology, and texturizing the warped 3D representation of each object using corresponding image data. For non-rigid objects, warping information from previous frames is challenging as it conventionally requires estimating the displacement of each point on the object, rather than just the displacement of the object itself. As such, in some embodiments, non-rigid objects may be represented as flat 2D surfaces and texturized with corresponding image data. As such, the resulting texturized 3D surface topology may be rendered to generate a visualization of the surrounding environment. Compared to environmental modeling techniques such as those that model the surrounding environment as a 3D bowl, this surface topology visualization can provide a more accurate view of the surrounding environment. In this regard, nearby objects (e.g., mobile obstacles or a subclass thereof such as a vehicles, pedestrians, and/or others) are less likely to be obscured or omitted from the surface topology visualization. Farther objects, on the other hand may not be deformed or stretched out due to the mismatch of their geometry with that of the 3D bowl.

For example, one or more sensors (e.g., cameras) of an ego-machine such as a vehicle may be used to generate frames of sensor data (e.g., images) while the ego-machine navigates an environment. Any known depth estimation technique may be used to estimate the depth of the surrounding environment using the sensor data. In some embodiments, any number of frames of image data generated using any number of sensors may be (e.g., stacked into corresponding channels of a tensor and) applied to one or more neural networks to predict one or more corresponding depth maps (e.g., representing per-pixel depth estimates). In an example implementation, multiple frames generated using different sensors (e.g., cameras) and representing the same time slice may be grouped together to represent spatial context, multiple frames generated using the same sensor (e.g., camera) and representing different time slices may be grouped together to represent temporal context, and the resulting (e.g., stacked) representation of the image data may be applied to the neural network(s) to estimate one or more depth maps (a depth map corresponding to each frame of image data). As such, depth of the surrounding environment may be estimated using single view and/or multi-view cues.

In some embodiments, the one or more depth maps may be converted into 3D representation of the detected surface topology of the surrounding environment. For example, the geometry of the surrounding environment may be modeled as a 3D surface using a (e.g., truncated) signed distance function (SDF) that encodes the distance of each voxel in a 3D grid to the detected 3D surface topology represented by the one or more depth maps. In some scenarios, since the quality of depth estimation may degrade beyond some distance from the ego-machine, the distance to the detected 3D surface topology represented in the SDF may be truncated to some designated maximum value. As such, a truncated signed distance function (TSDF) may effectively clip the detected 3D surface topology to a spherical form with a designated radius. Generally, a new 3D representation of the detected surface topology of the surrounding environment (e.g., a (T) SDF) may be generated for each time slice, and/or the 3D representation of the detected surface topology from a previous time slice may be updated by adding and removing deltas (e.g., scene updates). Holes in the detected 3D surface topology of the surrounding environment (e.g., representing disocclusions for regions that were never observed) may be identified and filled using any known technique. As such, a 3D surface (e.g., a 3D mesh) may be extracted from the detected 3D surface topology represented in the (T) SDF, and may be smoothed using any known technique.

As such, the sensor data (e.g., the image data) may be back-projected onto the 3D surface representing the detected 3D surface topology (e.g., 3D surface mesh) using corresponding depth values (e.g., represented by the unsmoothed 3D surface representation, rendered using unstructured lumigraph rendering, etc.) in each back-projection to generate a texturized 3D surface. This process may be understood as backward warping a texture from the corresponding frames of image data (e.g., from any number of cameras and/or representing multiple time slices). Regions that are not covered by the texture (e.g., holes or other empty regions) may be unobserved, so those regions may be covered and/or otherwise represented using blurring. In some embodiments, texture mapping may use frames of image data representing one or more previous time slices, and uncovered or other identified stale regions may be visualized by desaturating colors, applying a tint, and/or other techniques.

In some embodiments, instead of texturizing the detected 3D surface topology with all the image data from the one more frames, dynamic objects may be detected and masked from texturizing, effectively creating a representation of the static portion of a scene. Any known technique may be applied to detect 2D and/or 3D bounding boxes or other bounding shapes representing any desired class of dynamic object (e.g., vehicles, vulnerable road users, etc.). As such, detected bounding shapes for one or more designated classes of dynamic objects may be detected (e.g., in each frame of image data), and the region(s) inside the detected bounding shape(s) may be masked from a first pass of texturizing.

Some embodiments may visualize rigid objects by tracking trajectories of (e.g., 3D bounding boxes or other bounding shapes) of detected objects of a designated class (e.g., classes of rigid objects like vehicles), identifying detected depth values representing the detected objects (e.g., based on the pixel correspondence between a segmentation map and corresponding depth map) in a previous time slice, and warping the detected depth values using a corresponding detected trajectory to generate a warped 3D representation (e.g., a 3D surface representation such as a 3D surface mesh corresponding to a detected 3D bounding box or other bounding shape) of each such object. Additionally or alternatively, some embodiments may visualize non-rigid objects of a designated class (e.g., classes of non-rigid objects like pedestrians) by modeling each such object as a flat 2D surface (e.g., a piece of cardboard), inserting or fusing the flat 2D surface at a location in the (e.g., texturized) 3D surface topology corresponding to the detected location (e.g., centroid of a 3D bounding box or other bounding shape) of the object, and texturizing the flat 2D surface using corresponding image data (from the detected region of a corresponding image frame representing the object).

As such, the techniques described herein may be utilized to visualize the environment surrounding an ego-machine more accurately than prior techniques. For example, estimating depth using multi-view cues and/or frames of sensor data representing different time slices provides a more accurate estimate of depth, and modeling the surrounding environment as a corresponding detected 3D surface topology provides a more accurate model of depth than prior techniques. As such, spatially aligning sensor data using these improved depth estimates results in better alignment and therefore fewer visual artifacts and better quality images. Furthermore, rendering dynamic objects by texturizing warped 3D representations of rigid objects and/or flat 2D surfaces representing non-rigid objects improves the quality of the resulting visualizations over prior techniques. As such, the techniques described herein may be used to reduce visual artifacts, improve visual representations of the surrounding environment, and therefore promote safe operation of the ego-machine.

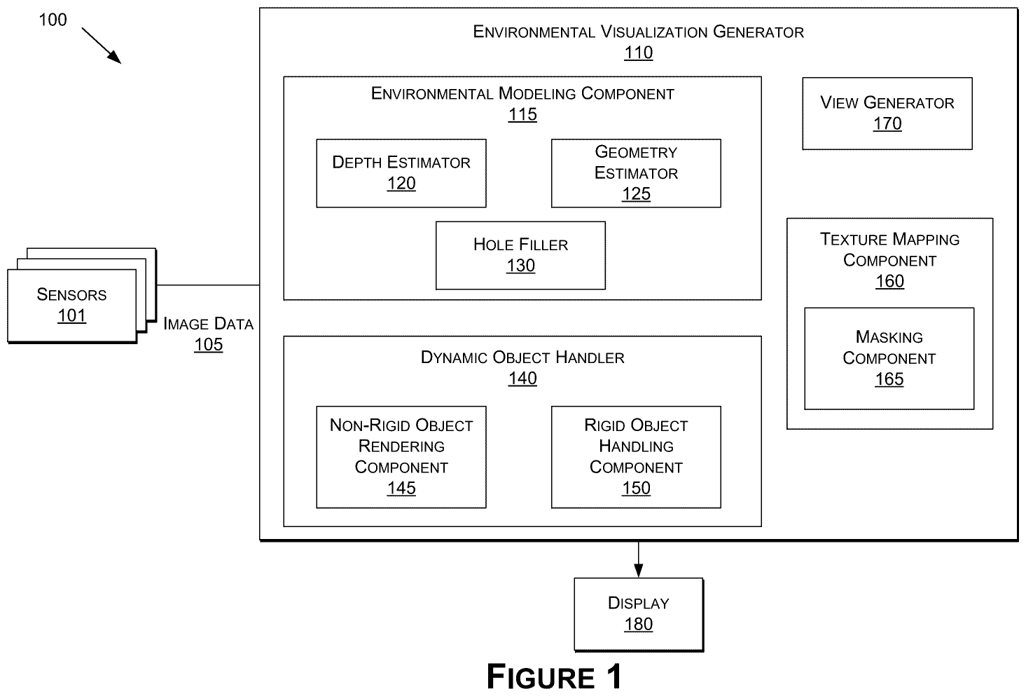

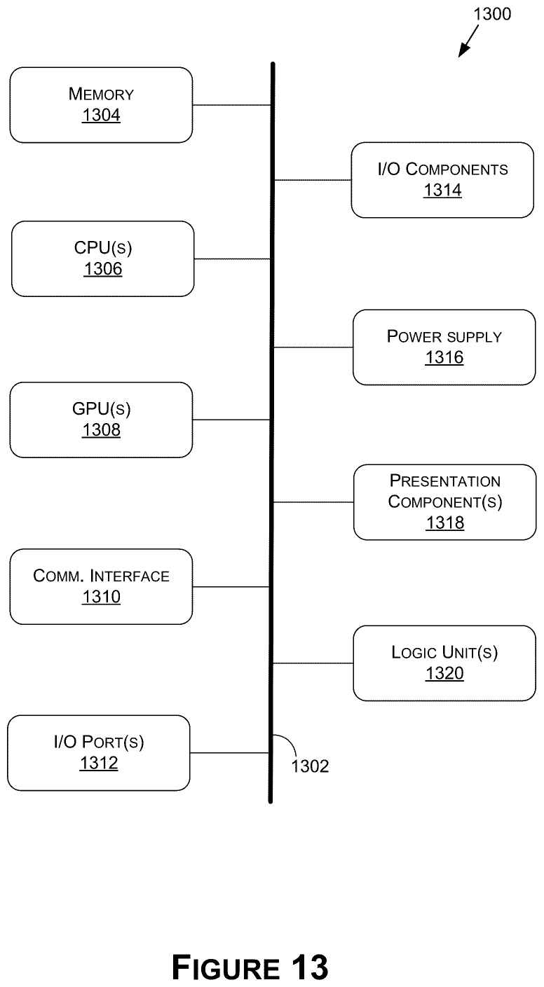

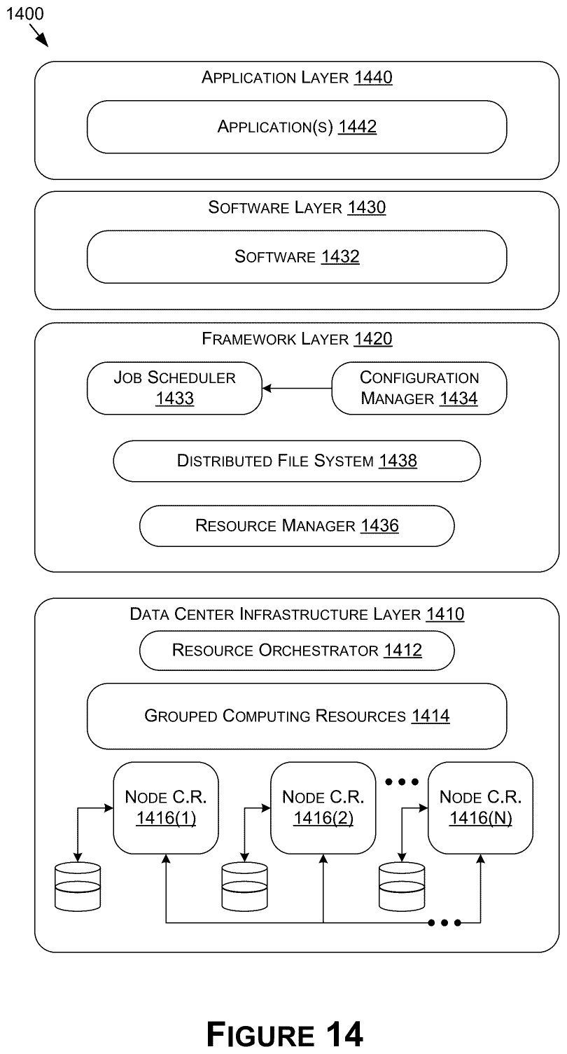

With reference to FIG. 1, FIG. 1 is an example environment visualization pipeline 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionalities to those of example autonomous vehicle 1200 of FIGS. 12A-12D, example computing device 1300 of FIG. 13, and/or example data center 1400 of FIG. 14.

As a high level overview, the environment visualization pipeline 100 may be incorporated into an ego-machine, such as the autonomous vehicle 1200 of FIGS. 12A-12D. The environment visualization pipeline 100 may include any number and type of sensor(s) 101 such one or more cameras that may be used to generate sensor data (e.g., image data 105) representing the surrounding environment. The environment visualization pipeline 100 may use the image data 105 to generate a visualization of the surrounding environment, and/or present it on a display 180 visible to an occupant or operator of the ego-object (e.g., a driver or passenger).

In an example embodiment, an ego-machine (e.g., the autonomous vehicle 1200 of FIGS. 12A-12D) is equipped with any number and type of sensor(s) 101 (e.g., one or more cameras, such as fisheye cameras), and the sensor(s) 101 may be used to capture frames of overlapping sensor data (e.g., overlapping image data) for each time slice. Generally, any suitable sensor may be used, such as one or more of the stereo camera(s) 1268, wide-view camera(s) 1270 (e.g., fisheye cameras), infrared camera(s) 1272, surround camera(s) 1274 (e.g., 360° cameras), and/or long-range and/or mid-range camera(s) 1298, of the vehicle 1200 of FIG. 12A. Typically, different sensors have their own 3D coordinate systems. As such, some embodiments align sensor data from the sensor(s) 101 (e.g., image data 105) in a coordinate system defined relative to the ego-machine, such as a vehicle rig coordinate system. Additionally or alternatively, the environment surrounding the ego-machine may be modeled in a global 3D coordinate system (world space), and the sensor data may be aligned in the global 3D coordinate system. In an example configuration, four fisheye cameras are installed at the front, left, rear and right side of a vehicle, where surrounding videos are continuously captured. Ego-motion of the vehicle may be generated using any known technique and synchronized with timestamps of the frames (e.g., images) of the videos. For example, absolute or relative ego-motion data (e.g., location, orientation, positional and rotational velocity, positional and rotational acceleration) may be determined using a vehicle speed sensor, gyroscope, accelerator, inertial measurement unit (IMU), and/or others.

In the embodiment illustrated in FIG. 1, the environment visualization pipeline 100 includes the sensor(s) 101, an environmental visualization generator 110, and a display 180. In example embodiments, the environmental visualization generator 110 may generate a 3D representation of the environment surrounding the ego-machine, such as a detected 3D surface topology using sensor data (e.g., image data 105) from the sensor(s) 101, texturize the detected 3D surface topology by projecting sensor data onto the detected 3D surface topology, and render a visualization of the texturized 3D surface topology (or project depth from the detected 3D surface topology into a corresponding visualization and texturize the visualization using the projected depth). For example, cameras of an ego-machine, such as a car, may record video or may otherwise capture images of the environment surrounding the ego-machine. The captured images may be processed by the environmental visualization generator 110 to generate a texturized 3D surface topology of the environment surrounding the car, and a view of the texturized 3D surface topology may be presented on the display 180.

In the embodiment illustrated in FIG. 1, the environmental visualization generator 110 includes an environmental modeling component 115 that generates a detected 3D surface topology of the surrounding environment, a texture mapping component 160 that texturizes the detected 3D surface topology using the sensor data, a dynamic object handler 140 that inserts and texturizes 3D representations of detected dynamic objects in the (e.g., texturized) detected 3D surface topology, and a view generator 170 that renders a view of the (e.g., texturized) detected 3D surface topology.

In some embodiments, the environmental modeling component 115 extracts depth values from sensor data from the sensor(s) 101, and models the surrounding environment as a detected 3D surface topology using the extracted depth values. In the embodiment illustrated in FIG. 1, the environmental modeling component 115 includes a depth estimator 120 that extracts depth associated with objects within the environment, a geometry estimator 125 that estimates the geometry of the surrounding environment, and a hole filler 130 that fills any number of holes or other regions of incomplete content, disocclusions, or other regions in the estimated geometry.

In some embodiments, the depth estimator 120 estimates distance and/or direction to detected surfaces and/or object(s) in the environment (e.g., using any known depth estimation technique), and the geometry estimator 125 may generate a 3D surface topology representing the surrounding environment based on the distance(s) and/or direction(s). In some embodiments, sensor data such as a LiDAR or RADAR point cloud representing detected surfaces and/or objects may be used to determine the location of surfaces and objects in the environment, and the depth estimator 120 may compute distances (e.g., to each point in a region of the surrounding environment).

In some embodiments, the depth estimator 120 may apply any number of frames of sensor data (e.g., image data 105) generated using any number of sensor(s) 101 across any number of time slices to one or more neural networks to generate or predict one or more corresponding depth maps. These extracted depth maps may represent per-pixel depth estimates corresponding to each image in a set of images. The depth estimator 120 may group multiple frames representing the same time slice and generated using different sensors 101 to represent spatial context. Additionally or alternatively, the depth estimator 120 may group multiple frames representing different time slices and generated using the same sensor to represent temporal context. Any grouping of frames, image data, and/or other sensor data may be applied to the one or more neural networks. As such, the depth estimator 120 may estimate depth corresponding to each frame of image data (e.g., using single view and/or multi-view cues).

In some embodiments, the depth estimator 120 is implemented using neural network(s) such as a convolutional neural network (CNN), but this is not intended to be limiting. For example, and without limitation, the depth estimator 120 (and/or other components described here) may include any type of a number of different networks or machine learning models, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, transformer, recurrent, perceptrons, Long/Short Term Memory (LSTM), Hopfield, Boltzmann, deep belief, de-convolutional, generative adversarial, liquid state machine, etc.), and/or other types of machine learning models.

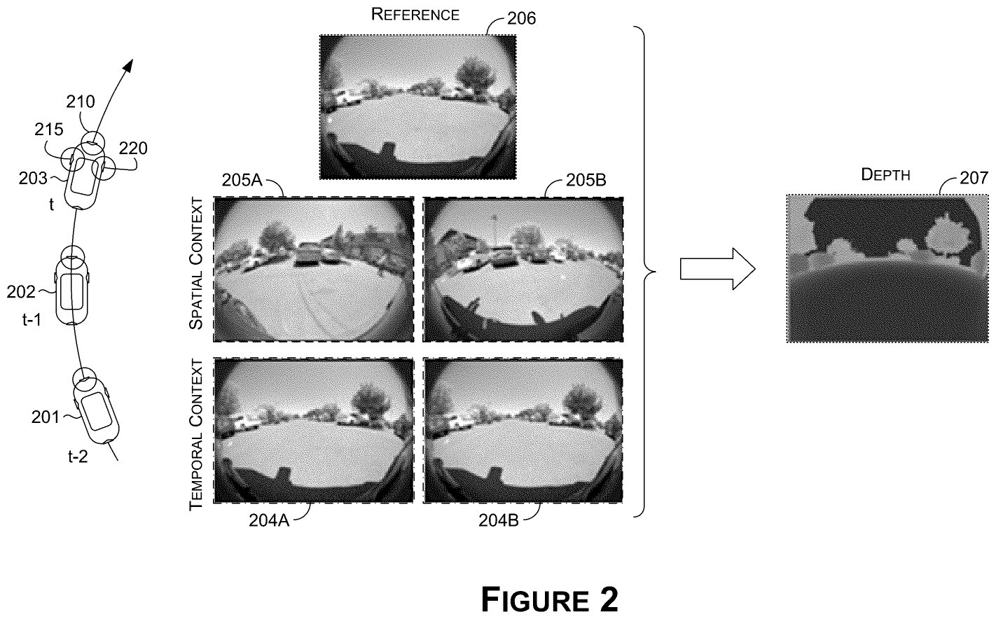

FIG. 2 illustrates an example scenario in which depth may be estimated using frames of image data representing spatial and/or temporal context, in accordance with some embodiments of the present disclosure. Generally, an ego-machine (such as the car depicted in FIG. 12A-D) may be equipped with any number of sensors (e.g., cameras) located at any number of locations on or in the ego-machine. The sensors may be used to generate frames of sensor data for any number of time slices. For example, FIG. 2 illustrates a car equipped with a front facing camera 210, a left facing camera 215, and a right facing camera 220, which may be used to generate frames of image data as the car navigates an environment during a first time slice 201, a second time slice 202, and a third time slice 203. For example, the front facing camera 210 may be used to generate an image 206, the left facing camera 215 may be used to generate an image 205A, and the right facing camera 220 may be used to generate an image 205B, all representing a common time slice (e.g., the time slice 203). Taking one of the cameras such as the front facing camera 210 as a reference, that same camera may be used to generate images (e.g., image 204A, 204B) representing other time slices (e.g., the time slices 202, 201). As such, the cameras may be used to generate image data representing temporal context (e.g., via image data from different time slices such as the images 206, 204A, and 204B) and/or spatial context (e.g., via image data generated using different cameras for the same time slice such as the images 206, 205A, and 205B).

As such, images representing different views of the environment and/or different time slices may be combined (e.g., stacked) and used to extract one or more depth values (e.g. by the depth estimator 120 of FIG. 1). For example, image data generated using a reference camera and representing a first time slice may be combined with a) image data generated using other cameras and representing the first time slice, and/or b) image data generated using the reference camera and representing the other time slices to generate a combined representation, and the combined representation of the image data may be applied to a neural network to extract depth data (e.g., a depth map) corresponding to the field of view of the reference camera. FIG. 2 illustrates an example depth map 207 corresponding to the image 206 generated using the front facing camera 210. As such, a depth map corresponding to any number and type of reference sensor may be generated.

Returning now to FIG. 1, in some embodiments, the geometry estimator 125 may convert depth values (e.g., one or more depth maps) generated by the depth estimator 120 into a 3D representation of a detected 3D surface topology of the surrounding environment. Any method of generating 3D representations of an environment based on depth data or depth maps may be used. For example, the geometry estimator 125 may model the geometry of the surrounding environment as a 3D surface using a signed distance function (SDF) which encodes the distance of each voxel in a 3D grid from the detected 3D surface topology represented by one or more depth maps. In some embodiments, the quality of depth estimation may degrade beyond some distance from the ego-machine, so the geometry estimator 125 may truncate the distance to the detected 3D surface topology represented in the SDF to some designated maximum value. As such, a truncated signed distance function (TSDF) may effectively clip the detected 3D surface topology to a spherical form with a designated radius. The SDF may additionally or alternatively be truncated to any designated maximum distance in any direction, and/or using any other suitable geometric shape. In some embodiments, the geometry estimator 125 may generate an SDF for each time slice and/or for each of the one or more sensor(s) 101 (and combined, for example, by averaging distance values derived from overlapping regions of overlapping depth maps). The geometry estimator 125 may additionally or alternatively update an SDF from a previous time slice by adding and removing detected deltas such as detected depth values corresponding to regions of detected movement or other detected changes.

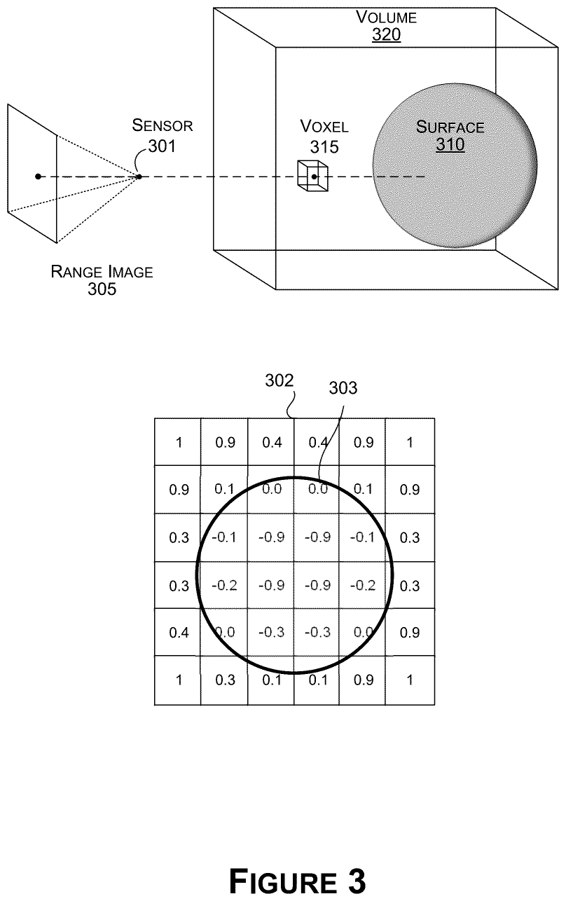

FIG. 3 illustrates an example 3D representation of a detected 3D surface topology, in accordance with some embodiments of the present disclosure. More specifically, FIG. 3 represents how a sensor 301 viewing a 3D surface 310 may be used to generate a SDF represented by grid 302 representing the surface 310. For example, the sensor 301 may be used to generate a range image 305 representing the distance between the sensor 301 and the portion of the surface 310 represented by a corresponding pixel of the range image 305. As such, the range image 305 may encode the distance between the sensor 301 and the surface 310. By contrast, a SDF may encode the distance between each voxel 315 in a volume 320 and its closest point on the surface 310. The grid 302 illustrates a cross-section of the volume 320 and an extracted boundary 303 of the volume 320 (illustrated as a circle).

Generally, an SDF is a representation which may used in 3D reconstruction and computer graphics to model the surface geometry of objects or scenes. It may describe the distance from each point in 3D space (e.g., the voxel 315 in the volume 320) to the nearest surface of an object (e.g., the surface 310), and includes signs that indicate whether the point lies inside (negative distance) or outside (positive distance) the surface. For example, the positive numbers outside of the extracted boundary 303 in the gird 302 indicate that those cells represent points that are outside the volume 320, the negative numbers inside the extracted boundary 303 indicate that those cells represent points that are inside the surface 310, and cells with zeros represent points that are on the surface 310.

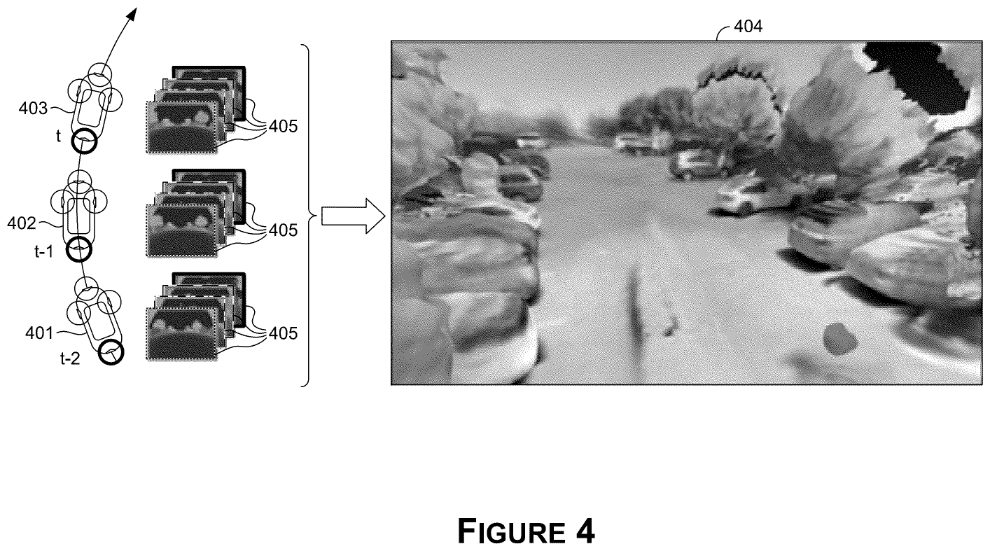

Returning to FIG. 1, the geometry estimator 125 may extract a 3D surface representation of the detected 3D surface topology, such as a 3D mesh, from the detected 3D surface topology represented in the SDF, and the geometry estimator 125 may apply any known smoothing technique to the extracted 3D mesh (and/or the detected 3D surface topology). FIG. 4 illustrates an example view 404 of a detected 3D surface topology, in accordance with some embodiments of the present disclosure. This example illustrates an implementation in which each of four cameras (e.g., front facing, left facing, right facing, rear facing) is used to generate four corresponding depth maps in each of three time slices 401, 402, 403), resulting in twelve total depth maps 405. As such, the depth maps 405 may be converted (e.g., by the geometry estimator 125 of FIG. 1) into a 3D representation (e.g., SDF, TSDF, 3D surface mesh) of a detected 3D surface topology. In the view 404 in FIG. 4, the detected 3D surface topology has been texturized (e.g., by the texture mapping component 160 of FIG. 1) with image data to illustrate the detected depth of the 3D surface topology.

Returning to FIG. 1, in some embodiments, the hole filler 130 may fill one or more detected holes or other regions of incomplete content in one of the 3D representations of the detected 3D surface topology (e.g., the SDF, the extracted 3D surface mesh). As such, depending on the implementation, the 3D surface representation may be extracted before or after the hole filler 130 has repaired or filled any holes, disocclusions, or other regions in the detected 3D surface topology. In some embodiments, the hole filler 130 may identify and fill holes, disocclusions, and/or any missing and/or corrupted content or other data in the detected 3D surface topology of the surrounding environment using any known technique. For example, the hole filler 130 may identify voxels representing missing or inconsistent information in the SDF by examining and detecting structural coherence within regions of the detected 3D surface topology, examining and detecting discontinuities in the corresponding depth values represented by the detected 3D surface topology, and/or otherwise. Additionally or alternatively, the hole filler 130 may using any known technique to generate graphical data to replace the one or more regions of incomplete content, for example, using any suitable hole filling techniques such as 3D inpainting to fill in identified holes or other regions of incomplete content, disocclusions, and/or any missing and/or corrupted data in the detected 3D surface topology.

In some embodiments, the texture mapping component 160 may texturize or otherwise apply a graphical representation of visual elements (e.g., colors, images, designs, patterns, etc.) to the detected 3D surface topology (e.g., an extracted 3D surface mesh) and/or a 2D view of the detected 3D surface topology by projecting the sensor data (e.g., the image data 105) using depth values derived from the detected 3D surface topology and/or generated by the depth estimator 120. For example, the texture mapping component 160 may map the image data 105 onto a 3D surface topology or some other 3D representation of the surrounding environment to generate a textured 3D model of the environment (e.g., a textured 3D surface topology). In some embodiments, to perform texturizing, the texture mapping component 160 back-projects 2D points in pixel coordinates to 3D points using corresponding depth values obtained from the detected 3D surface topology (e.g., an SDF, an extracted surface mesh), from a sensed or extracted depth map (e.g., generated using LiDAR or RADAR sensor(s), generated by the depth estimator 120 using one or more neural networks, etc.), and/or otherwise. With the image data assigned to corresponding 3D points, the texture mapping component 160 may project the 3D points, for example, into the 3D surface topology to generate a texturized 3D surface topology.

As such, in some embodiments, the texture mapping component 160 may back-project image data from the sensor(s) 101 onto the 3D surface representation of the detected 3D surface topology using corresponding depth values (e.g., represented by the unsmoothed 3D surface representation, rendered using unstructured lumigraph rendering, etc.) in each back-projection to generate a texturized 3D surface. In some embodiments (e.g., in which depth values are extracted from a current and/or prior time slices), textures may be backwards warped from corresponding frames of image data from any number of sensor(s) 101 and/or corresponding time slices. In some implementations, regions that are not covered by the texture may be determined to be outdated or stale. As such, the texture mapping component 160 may cover detected outdated or stale regions and/or may otherwise represent such regions using blurring. Additionally or alternatively, the texture mapping component 160 may texturize the 3D surface topology using frames of image data representing one or more previous time slices, and may represent potentially stale or outdated regions by desaturating colors, applying a tint, and/or any other texturing technique.

As such, the view generator 170 may render a view of texturized detected 3D surface topology (e.g., a texturized 3D surface mesh), or the view generator 170 may generate a view (e.g., a 2D image with placeholder pixels) of the untexturized detected 3D surface topology, the texture mapping component 160 may project depth values into the 2D view (e.g., generating a corresponding depth map), and the texture mapping component 160 may texturize the 2D view using corresponding (e.g., per-pixel) depth values. For example, the view generator 170 may position and orient a virtual camera in a 3D scene with the 3D surface topology and render a view of the textured 3D surface topology from the perspective of the virtual camera through a corresponding viewport. In some embodiments, the viewport may be selected based on a driving scenario (e.g., orienting the viewport in the direction of ego-motion), based on a detected salient event (e.g., orienting the viewport toward the detected salient event), based on an in-cabin command (e.g., orienting the viewport in a direction instructed by a command issued by an operator or occupant of the ego-machine), based on a remote command (orienting the viewport in a direction instructed by a remote command), and/or otherwise. As such, the view generator 170 may output a visualization (e.g., a surround view visualization) of the surrounding environment to the display 180 (e.g., a monitor visible to an occupant or operator of the ego-machine).

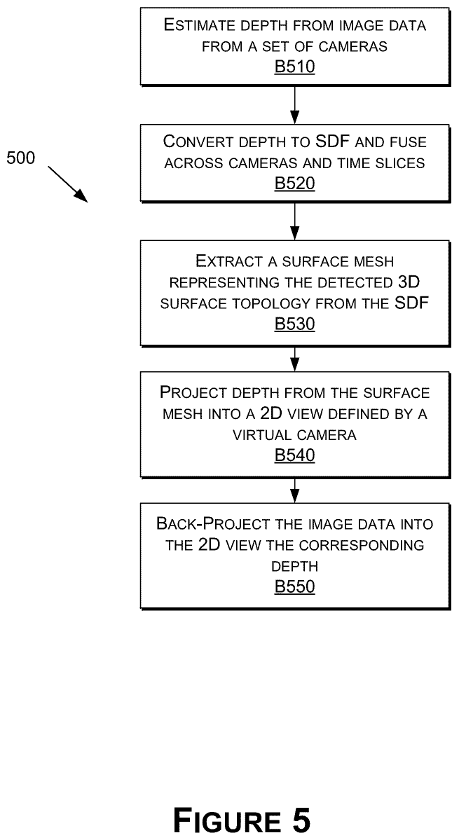

Now referring to FIG. 5, each block of methods 500, 600, 1000, and 1100 described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. In addition, the methods 500, 600, 1000, and 1100 are described, by way of example, with respect to the environmental visualization pipeline of FIG. 1. However, these methods may additionally or alternatively be executed by any one system, or any combination of systems, including, but not limited to, those described herein.

FIG. 5 is a flow diagram showing a method 500 for generating a visualization of an environment using a signed distance field, in accordance with some embodiments of the present disclosure. The method 500, at block B510, includes estimating depth from image data from a set of cameras. For example, with respect to FIG. 1, the depth estimator 120 may estimate distance and/or direction to detected surfaces and/or object(s) in the environment (e.g., using any known depth estimation technique). The depth estimator 120 may apply any number of frames of sensor data (e.g., image data 105) generated using any number of sensor(s) 101 across any number of time slices to one or more neural networks to generate or predict one or more corresponding depth maps. These extracted depth maps may represent per-pixel depth estimates corresponding to each image in a set of images. The depth estimator 120 may group multiple frames representing the same time slice and generated using different sensors 101 to represent spatial context. Additionally or alternatively, the depth estimator 120 may group multiple frames representing different time slices and generated using the same sensor to represent temporal context. Any grouping of frames, image data, and/or other sensor data may be applied to the one or more neural networks. As such, the depth estimator 120 may estimate depth corresponding to each frame of image data (e.g., using single view and/or multi-view cues). In embodiments, depth may be estimated for any number of objects within the image data of the set of cameras, whether static or dynamic.

At block 520, depth values (e.g., a depth map corresponding to each of a plurality of images) are converted to an SDF (e.g., a TSDF). For example, each depth map (e.g., corresponding to each image generated using each camera in each time slice) may be converted to a corresponding SDF (e.g., TSDF), and the SDFs may be fused together (e.g., by combining overlapping depth values such as by averaging). For example, with respect to FIG. 1, the geometry estimator 125 may generate a 3D surface topology representing the surrounding environment based on detected depth and/or direction(s) to detected objects and/or surfaces. In some embodiments, the geometry estimator 125 may convert depth values (e.g., one or more depth maps) generated by the depth estimator 120 into a 3D representation of a detected 3D surface topology of the surrounding environment. Any method of generating 3D representations of an environment based on depth data or depth maps may be used. For example, the geometry estimator 125 may model the geometry of the surrounding environment as a 3D surface using an SDF, and may generate (e.g., and fuse) any number of SDFs to represent a detected 3D surface topology of the surrounding environment for a given time slice.

At block B530, a surface mesh representing the detected 3D surface topology is extracted from the SDF. In embodiments, extracting the surface mesh comprises traversing the SDF and identifying points where the sign of the encoded distance changes, indicating the presence of a surface. The points of the surface may be connected to form triangles, creating an extracted mesh that approximates the underlying geometry.

At B540, depth is projected from the surface mesh into a 2D view defined by a virtual camera. For example, with reference to FIG. 1, the view generator 170 may generate a view (e.g., a 2D image with placeholder pixels for range, depth, and/or color values) of the detected 3D surface topology from the perspective of a virtual camera positioned and oriented in the 3D scene, and the texture mapping component 160 may generate a corresponding depth map (or populate placeholder pixels) representing the distance between each pixel and the detected 3D surface topology.

At B550, image data may be back-projected into the 2D view utilizing the corresponding depth. For example, with reference to FIG. 1, the texture mapping component 160 may texturize the 2D view using corresponding (e.g., per-pixel) depth values from the depth map. The texture mapping component 160 may texturize the 2D view of the detected 3D surface topology by projecting the sensor data (e.g., the image data 105) using the projected depth values from the depth map. In some embodiments, a depth map may be extracted from a representation of a detected 3D surface topology prior to texturizing the depth map or generating an image using corresponding values from the depth map. Additionally or alternatively, depth and color values may be determined on a per-pixel basis, for example, by extracting a depth value for a given pixel and back-projecting the color from a corresponding pixel of image data using the extracted depth value prior to advancing to the next pixel. This is meant simply as an example, and other variations are possible (e.g., texturing the 3D surface mesh prior to rendering a view of the texturized surface mesh, as illustrated in the following flow diagram).

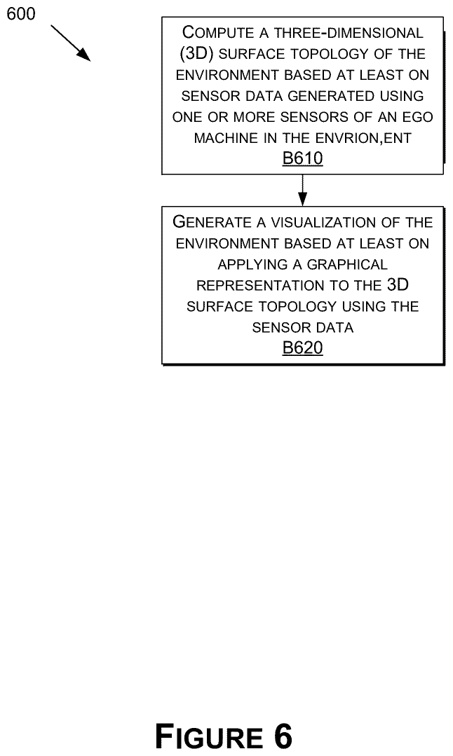

FIG. 6 is a flow diagram showing a method 600 for generating a visualization of an environment based at least on a 3D surface topology of the environment, in accordance with some embodiments of the present disclosure. The method 600, at block B610, includes computing a 3D surface topology of the environment based at least on sensor data generated using one or more sensors of an ego-machine in the environment. For example, with reference to FIG. 1, the depth estimator 120 of the environmental modeling component 115 may generate a depth map utilizing sensor data such as image data 105, and the geometry estimator 125 of the environmental modeling component 115 may detect a 3D surface topology representing the surrounding environment based on the depth map or any other depth data generated by the depth estimator 120.

At block B620, the method includes generating a visualization of the environment based at least on applying a graphical representation to the 3D surface topology using the sensor data. For example, with reference to FIG. 1, the texture mapping component 160 may texturize a representation of the detected 3D surface topology (e.g., an extracted 3D surface mesh) by projecting the sensor data (e.g., the image data 105) using depth values derived from the detected 3D surface topology and/or generated by the depth estimator 120. For example, the texture mapping component 160 may map the image data 105 onto a 3D surface topology or some other 3D representation of the surrounding environment to generate a textured 3D model of the environment (e.g., a textured 3D surface topology), and the view generator 170 may render a view of the texturized detected 3D surface topology.

In some embodiments, instead of texturizing (e.g., the detected 3D surface topology and/or a corresponding 2D view) with all the sensor data (e.g., image data 105) from the one more frames, dynamic objects may be detected and masked from texturizing, effectively creating a representation of the static portion of a scene, and a dynamic object handler 140 may insert and texturize 3D representations of detected dynamic objects in the (e.g., texturized) detected 3D surface topology.

For example and returning to FIG. 1, in some embodiments, the texture mapping component 160 may include a masking component 165 that masks detected dynamic objects from the sensor data (e.g., the image data 105) being used to texturize (e.g., the detected 3D surface topology, a 2D view of the detected 3D surface topology). For example, dynamic objects may be detected (e.g., by one or more upstream components using any known technique, such as using computer vision and/or motion detection) from the sensor data (e.g., the image data 105), one or more masks or other representation(s) of the detected dynamic objects may be generated, and the masking component 165 may omit sensor data identified by the one or more masks as representing the detected dynamic objects from texturizing. More specifically, any known technique may be applied to detect 2D and/or 3D bounding boxes or other bounding shapes representing any class of dynamic object (e.g., vehicles, road users, moving objects) (e.g., from each frame of image and/or sensor data), and the detected bounding shapes may be provided to the masking component 165, which may mask the corresponding region or regions inside the detected bounding shapes from texturizing. These embodiments effectively serve to generate a texturized 3D surface topology representing detected static parts of the environment (e.g., surrounding an ego-machine).

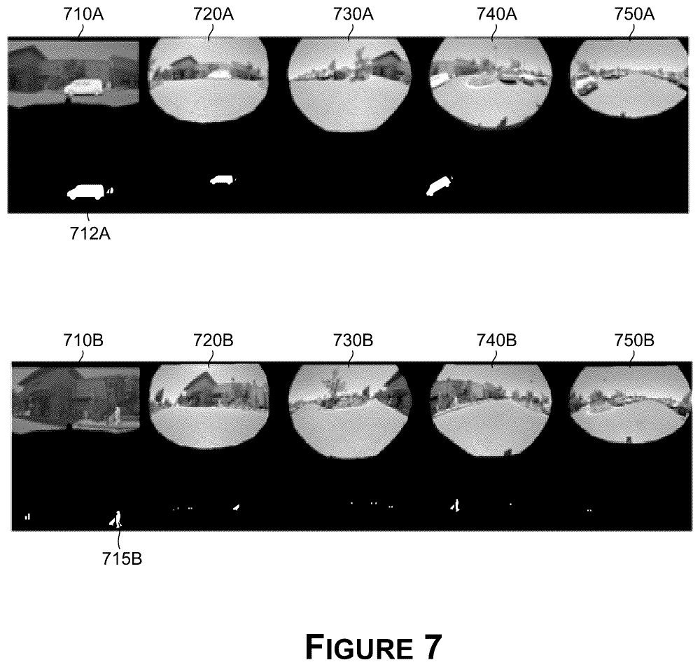

FIG. 7 illustrates an example scenario in which dynamic objects may be detected using frames of image data, in accordance with some embodiments of the present disclosure. Generally, an ego-machine (such as the car depicted in FIG. 12A-D) may be equipped with any number of sensors (e.g., cameras) located at any number of locations on or in the ego-machine. The sensors may be used to generate frames of sensor data for any number of time slices. For example, FIG. 7 illustrates image data captured by five sensors of an ego-machine. Images 710A, 720A, 730A, 740A, and 750A represent example images generated by a dashboard camera and surround view fisheye cameras for a first time slice, and images 710B, 720B, 730B, 740B, and 750B represent corresponding images for a second time slice. These images and/or other sensor data may be used (e.g., by the dynamic object handler 140 of FIG. 1 or some other component) to detect dynamic objects of one or more designated classes and generate a corresponding representation (e.g., a binary mask) delineating regions (e.g., pixels) of the images and/or other sensor data predicted to represent detect dynamic objects. FIG. 7 illustrates example dynamic object masks below each corresponding image. For example, a van 712A was detected from the image 710a, and a pedestrian 715B was detected from the image 710B, to highlight a few examples.

Generally, any known technique may be used to detect dynamic objects of any suitable class, such as one or more classes of rigid dynamic objects (e.g., vehicles, subclasses thereof such as cars and vans, etc.) and/or one or more classes of non-rigid dynamic objects (e.g., pedestrians, subclasses thereof such as pedestrians with strollers, other vulnerable road users, etc.). For example, sensor data from any number and type of sensor may be stacked and applied to one or more machine learning model(s) (e.g., one or more neural networks), for example, which may include an output channel for each class of object to detect. In some embodiments, sensor data may be accumulated, ego-motion compensated, projected, and/or converted to some representation that the machine learning model(s) accept. For example and returning to FIG. 1, in some embodiments in which the data from sensors 101 includes a representation of measured 3D points (e.g., LiDAR or RADAR point clouds), the measured 3D points (and/or other data) may be accumulated (e.g., over a designated number of time slices, LiDAR or RADAR spins, etc.), transformed to a single coordinate system (e.g., centered around an origin of a rig coordinate system of the ego-machine), ego-motion-compensated (e.g., to a latest known position of the ego-machine), and/or projected to form a projection image representing any suitable view of the 3D environment (e.g., perspective, orthographic), having any number of channels (e.g., a single channel image, a multi-channel image or tensor) representing any characteristic of the data from sensors 101 (e.g., projected position of a measured 3D point, one or more reflection characteristics, image data such as pixel color, etc.). For example, an (accumulated, ego-motion-compensated) LiDAR point cloud may be projected to form a LiDAR range image with a perspective view or a top-down representation of projected 3D locations of measured 3D points (e.g., a height map), with any number of channels (e.g., storing intensity, elevation or range profile, etc.). In some embodiments, one or more sensors 101 (whether the same type or a different of sensor) may be used to generate different modalities of sensor data (e.g., LiDAR range images, camera images, etc.) having the same (e.g., perspective) view of the 3D environment in a common image space, and sensor data from the different sensors 101 and/or sensor modalities may be stored in different channels of a multi-channel image or tensor. These are meant simply as examples, and other variations are contemplated within the scope of the present disclosure.

As such, some representation of the sensor data may be applied to the machine learning model(s) (e.g., by one or more upstream components, by the dynamic object handler 140, etc.), and the machine learning model(s) may extract classification data (e.g., class confidence data for any number of classes and/or corresponding channels) and/or object instance data (e.g., a representation of a bounding shape) for each detected dynamic object in the 3D environment. The classification data and object instance data may be post-processed to generate class labels, 2D and/or 3D bounding boxes, closed polylines, or other bounding shapes identifying the locations, geometry, and/or orientations of the detected object instances. As such, the one or more sensors 101 may be used to generate one or more frame(s) of the sensor data for each time slice (e.g., at a particular frame rate, such as 30 frames per second (fps)), and the frame(s) of sensor data for each time slice may be used to detect, generate a representation of, monitor, and/or track the locations of detected dynamic objects of one or more designated classes (e.g., of rigid and/or non-objects) in the surrounding environment (whether at the same frame rate as the sensor data is generated or some other frame rate).

The dynamic object handler 140 may include a rigid object rendering component 150 that represents and texturizes detected rigid objects as warped 3D representations and/or a non-rigid object rendering component 145 that represents and texturizes detected non-rigid objects as flat 2D surfaces.

In some embodiments, the rigid object rendering component 150 (or some other component) may track trajectories (e.g., bounding boxes or other bounding shapes) of detected objects of a designated class of rigid objects (e.g., vehicles, subclasses thereof) over time, identify detected depth values representing the detected objects (e.g., based on the pixel correspondence between a segmentation map and corresponding depth map) in a previous time slice, and warp the detected depth values using a corresponding detected trajectory to generate a warped 3D representation (e.g., a 3D surface representation such as a 3D surface mesh corresponding to a detected 3D bounding box or other bounding shape) of each detected object. The rigid object rendering component 150 may insert or fuse the warped 3D representation of each detected object into the texturized or not yet texturized detected 3D surface topology of the surrounding environment, and may texturize the warped 3D representation of each detected object using corresponding image data (e.g., identified by a corresponding mask(s)). Warping depth data from a previous time slice often results in a better representation of moving objects than simply relying on depth data from a current time slice.

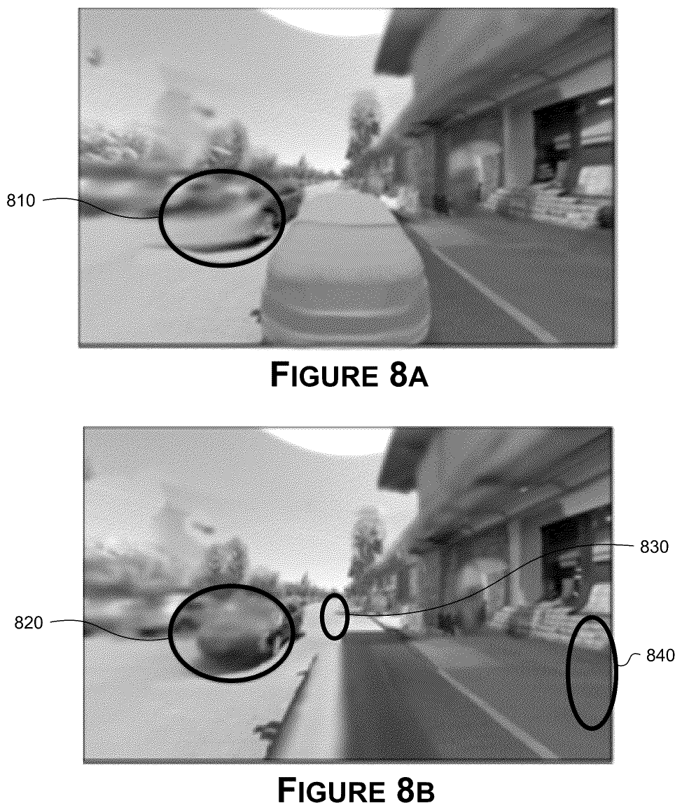

FIGS. 8A-8B illustrate an example scenario in which a rigid dynamic object may be inserted into a 3D surface topology of an environment, in accordance with some embodiments of the present disclosure. For example, FIG. 8A illustrates a view of a 3D surface topology of the environment surrounding a vehicle. In this example, region 810 shows a moving car with blurring. As such, FIG. 8B illustrates a view of the 3D surface topology with a warped representation of that car from a previous time slice inserted into a corresponding region 820. As illustrated, the warped representation from a previous time slice provides a better representation of the moving car than simply relying on depth data from a current time slice.

Returning to FIG. 1, the non-rigid object rendering component 145 may visualize non-rigid objects of a designated class of non-rigid objects (e.g., pedestrians, other vulnerable road users, subclasses thereof) by modeling each such object as a 3D representation of a flat 2D surface (e.g., a piece of cardboard or a 2D rectangle), inserting or fusing the flat 2D surface at a location in the 3D surface topology corresponding to the detected location (e.g., a centroid of a 3D bounding box or other bounding shape) of the object, and texturizing the flat 2D surface using corresponding image data (e.g., identified by a corresponding mask(s)). Representing non-rigid objects as flat 2D surface often results in a better representation of moving objects than simply relying on depth data from a current time slice.

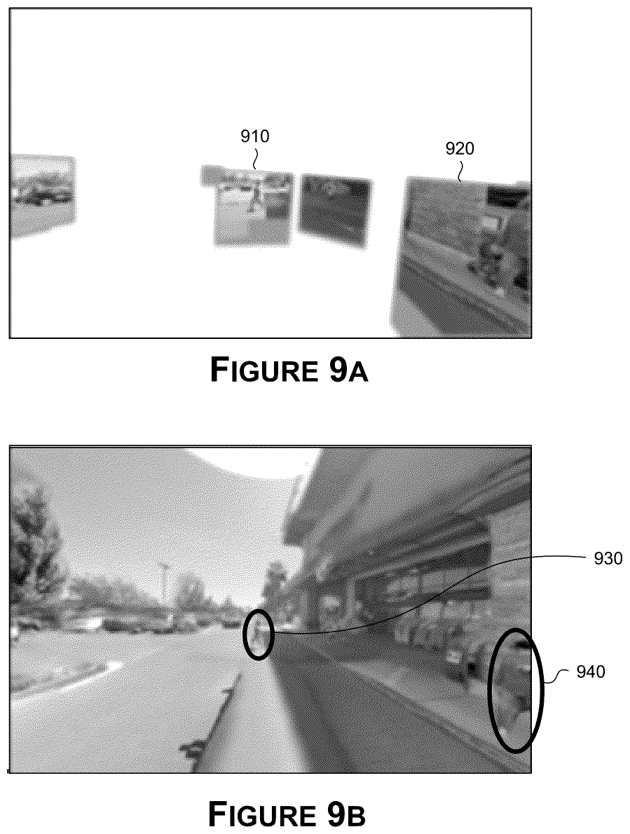

By way of illustration, notice how regions 830 and 840 in FIG. 8B do not depict pedestrians that were present in the scene. FIGS. 9A-9B illustrate a corresponding scenario in which a set of non-rigid dynamic objects may be inserted into the 3D surface topology. For example, FIG. 9A illustrates a view of flat 2D surfaces (e.g., surfaces 910 and 920) at locations corresponding to the positions in the 3D surface topology where non-rigid objects (e.g., pedestrians) were detected, and FIG. 9B illustrates a view of the 3D surface topology where the flat 2D surfaces have been texturized using corresponding image data. As such, regions 930 and 940 depict the pedestrians that were present in the scene.

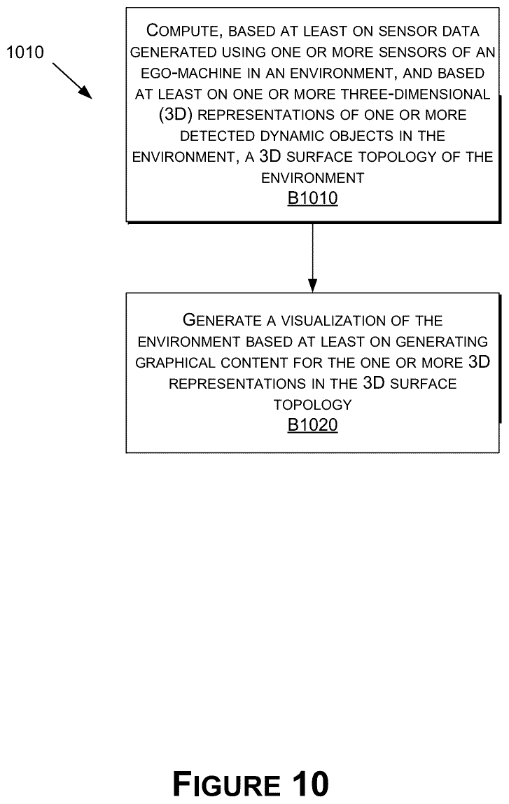

FIG. 10 is a flow diagram showing a method 1000 for generating a visualization of an environment with dynamic objects, in accordance with some embodiments of the present disclosure. The method 1000, at block B1010, includes computing, based at least on sensor data generated using one or more sensors of an ego-machine in an environment, and based at least on one or more 3D representations of one or more detected dynamic objects in the environment, a 3D surface topology of the environment. For example, with reference to FIG. 1, the environmental modeling component 115 may generate a detected 3D surface topology of the surrounding environment, and the dynamic object handler 140 may generate and insert 3D representations of detected dynamic objects. For example, the dynamic object handler 140 (or some other component) may use sensor data (e.g., image data) to detect dynamic objects of one or more designated classes and generate a corresponding representation (e.g., a binary mask) delineating regions (e.g., pixels) of the images and/or other sensor data predicted to represent detect dynamic objects. Generally, any known technique may be used to detect dynamic objects of any suitable class, such as one or more classes of rigid dynamic objects (e.g., vehicles, subclasses thereof such as cars and vans, etc.) and/or one or more classes of non-rigid dynamic objects (e.g., pedestrians, subclasses thereof such as pedestrians with strollers, other vulnerable road users, etc.). The dynamic object handler 140 may include a rigid object rendering component 150 that generates and inserts detected rigid objects as warped 3D representations and/or a non-rigid object rendering component 145 that generates and inserts detected non-rigid objects as flat 2D surfaces.

At block B1020, the method comprises generating a visualization of the environment based at least on generating graphical content for the one or more 3D representations in the 3D surface topology using the sensor data. For example, with reference to FIG. 1, the dynamic object handler 140 may texturize 3D representations of detected dynamic objects in the (e.g., texturized) detected 3D surface topology. For example, the rigid object rendering component 150 may texturize the warped 3D representations of the detected rigid objects, and/or the non-rigid object rendering component 145 may texturize the flat 2D surfaces representing the detected non-rigid objects using corresponding sensor (e.g., image data).

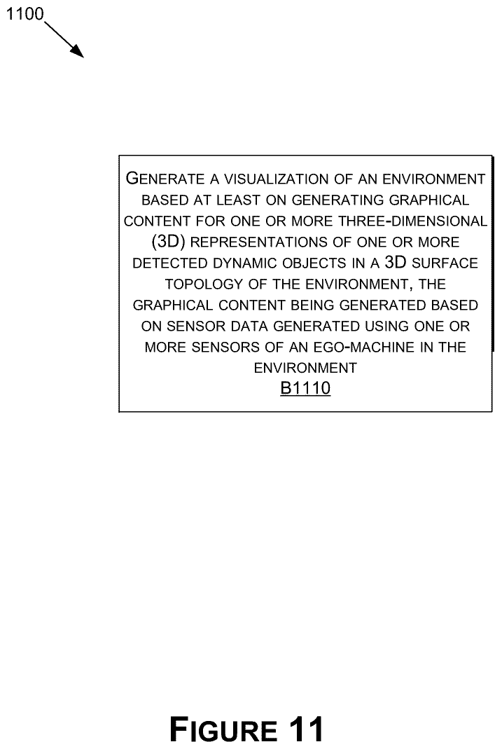

FIG. 11 is a flow diagram showing a method 1100 for generating a visualization of an environment based at least on generating graphical content for one or more 3D representations of one or more detected dynamic objects, in accordance with some embodiments of the present disclosure. The method 1100, at block B1110, includes generating a visualization of an environment based at least on generating graphical content for one or more 3D representations of one or more detected dynamic objects in a 3D surface topology of the environment, the graphical content being generated based on sensor data generated using one or more sensors of an ego-machine in the environment. For example, with reference to FIG. 1, the environmental modeling component 115 may generate a detected 3D surface topology of the surrounding environment, the dynamic object handler 140 may generate and insert 3D representations of detected dynamic objects into the detected 3D surface topology, the texture mapping component 160 may texturize the detected 3D surface topology, the dynamic object handler 140 may texturize the 3D representations of detected dynamic objects, and the view generator may render a view of the (e.g., texturized) detected 3D surface topology.

The systems and methods described herein may be used by, without limitation, non-autonomous vehicles, semi-autonomous vehicles (e.g., in one or more adaptive driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing, generative AI, and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems implementing one or more language models-such as one or more large language models (LLMs), systems for performing light transport simulation, systems for performing collaborative content creation for 3D assets, systems implemented at least partially using cloud computing resources, and/or other types of systems.

### Example Autonomous Vehicle

FIG. 12A is an illustration of an example autonomous vehicle 1200, in accordance with some embodiments of the present disclosure. The autonomous vehicle 1200 (alternatively referred to herein as the “vehicle 1200”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1200 may be capable of functionality in accordance with one or more of Level 3-Level 5 of the autonomous driving levels. The vehicle 1200 may be capable of functionality in accordance with one or more of Level 1-Level 5 of the autonomous driving levels. For example, the vehicle 1200 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1200 or other machine, such as being fully autonomous, being highly autonomous, being conditionally autonomous, being partially autonomous, providing assistive autonomy, being semi-autonomous, being primarily autonomous, or other designation.

The vehicle 1200 may include components such as a chassis, a vehicle body, wheels (e.g., 2, 4, 6, 8, 18, etc.), tires, axles, and other components of a vehicle. The vehicle 1200 may include a propulsion system 1250, such as an internal combustion engine, hybrid electric power plant, an all-electric engine, and/or another propulsion system type. The propulsion system 1250 may be connected to a drive train of the vehicle 1200, which may include a transmission, to allow the propulsion of the vehicle 1200. The propulsion system 1250 may be controlled in response to receiving signals from the throttle/accelerator 1252.

A steering system 1254, which may include a steering wheel, may be used to steer the vehicle 1200 (e.g., along a desired path or route) when the propulsion system 1250 is operating (e.g., when the vehicle is in motion). The steering system 1254 may receive signals from a steering actuator 1256. The steering wheel may be optional for full automation (Level 5) functionality.

The brake sensor system 1246 may be used to operate the vehicle brakes in response to receiving signals from the brake actuators 1248 and/or brake sensors.

Controller(s) 1236, which may include one or more system on chips (SoCs) 1204 (FIG. 12C) and/or GPU(s), may provide signals (e.g., representative of commands) to one or more components and/or systems of the vehicle 1200. For example, the controller(s) may send signals to operate the vehicle brakes via one or more brake actuators 1248, to operate the steering system 1254 via one or more steering actuators 1256, to operate the propulsion system 1250 via one or more throttle/accelerators 1252. The controller(s) 1236 may include one or more onboard (e.g., integrated) computing devices (e.g., supercomputers) that process sensor signals, and output operation commands (e.g., signals representing commands) to allow autonomous driving and/or to assist a human driver in driving the vehicle 1200. The controller(s) 1236 may include a first controller 1236 for autonomous driving functions, a second controller 1236 for functional safety functions, a third controller 1236 for artificial intelligence functionality (e.g., computer vision), a fourth controller 1236 for infotainment functionality, a fifth controller 1236 for redundancy in emergency conditions, and/or other controllers. In some examples, a single controller 1236 may handle two or more of the above functionalities, two or more controllers 1236 may handle a single functionality, and/or any combination thereof.

The controller(s) 1236 may provide the signals for controlling one or more components and/or systems of the vehicle 1200 in response to sensor data received from one or more sensors (e.g., sensor inputs). The sensor data may be received from, for example and without limitation, global navigation satellite systems (“GNSS”) sensor(s) 1258 (e.g., Global Positioning System sensor(s)), RADAR sensor(s) 1260, ultrasonic sensor(s) 1262, LiDAR sensor(s) 1264, inertial measurement unit (IMU) sensor(s) 1266 (e.g., accelerometer(s), gyroscope(s), magnetic compass(es), magnetometer(s), etc.), microphone(s) 1296, stereo camera(s) 1268, wide-view camera(s) 1270 (e.g., fisheye cameras), infrared camera(s) 1272, surround camera(s) 1274 (e.g., 360 degree cameras), long-range and/or mid-range camera(s) 1298, speed sensor(s) 1244 (e.g., for measuring the speed of the vehicle 1200), vibration sensor(s) 1242, steering sensor(s) 1240, brake sensor(s) (e.g., as part of the brake sensor system 1246), one or more occupant monitoring system (OMS) sensor(s) 1201 (e.g., one or more interior cameras), and/or other sensor types.

One or more of the controller(s) 1236 may receive inputs (e.g., represented by input data) from an instrument cluster 1232 of the vehicle 1200 and provide outputs (e.g., represented by output data, display data, etc.) via a human-machine interface (HMI) display 1234, an audible annunciator, a loudspeaker, and/or via other components of the vehicle 1200. The outputs may include information such as vehicle velocity, speed, time, map data (e.g., the High Definition (“HD”) map 1222 of FIG. 12C), location data (e.g., the vehicle's 1200 location, such as on a map), direction, location of other vehicles (e.g., an occupancy grid), information about objects and status of objects as perceived by the controller(s) 1236, etc. For example, the HMI display 1234 may display information about the presence of one or more objects (e.g., a street sign, caution sign, traffic light changing, etc.), and/or information about driving maneuvers the vehicle has made, is making, or will make (e.g., changing lanes now, taking exit 34B in two miles, etc.).

The vehicle 1200 further includes a network interface 1224 which may use one or more wireless antenna(s) 1226 and/or modem(s) to communicate over one or more networks. For example, the network interface 1224 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1226 may also allow communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 12B is an example of camera locations and fields of view for the example autonomous vehicle 1200 of FIG. 12A, in accordance with some embodiments of the present disclosure. The cameras and respective fields of view are one example embodiment and are not intended to be limiting. For example, additional and/or alternative cameras may be included and/or the cameras may be located at different locations on the vehicle 1200.

The camera types for the cameras may include, but are not limited to, digital cameras that may be adapted for use with the components and/or systems of the vehicle 1200. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1200 (e.g., front-facing cameras) may be used for surround view, to help identify forward facing paths and obstacles, as well aid in, with the help of one or more controllers 1236 and/or control SoCs, providing information critical to generating an occupancy grid and/or determining the preferred vehicle paths. Front-facing cameras may be used to perform many of the same ADAS functions as LiDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1270 that may be used to perceive objects coming into view from the periphery (e.g., pedestrians, crossing traffic or bicycles). Although only one wide-view camera is illustrated in FIG. 12B, there may be any number (including zero) of wide-view cameras 1270 on the vehicle 1200. In addition, any number of long-range camera(s) 1298 (e.g., a long-view stereo camera pair) may be used for depth-based object detection, especially for objects for which a neural network has not yet been trained. The long-range camera(s) 1298 may also be used for object detection and classification, as well as basic object tracking.

Any number of stereo cameras 1268 may also be included in a front-facing configuration. In at least one embodiment, one or more of stereo camera(s) 1268 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1268 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1268 may be used in addition to, or alternatively from, those described herein.

Cameras with a field of view that include portions of the environment to the side of the vehicle 1200 (e.g., side-view cameras) may be used for surround view, providing information used to create and update the occupancy grid, as well as to generate side impact collision warnings. For example, surround camera(s) 1274 (e.g., four surround cameras 1274 as illustrated in FIG. 12B) may be positioned to on the vehicle 1200. The surround camera(s) 1274 may include wide-view camera(s) 1270, fisheye camera(s), 360 degree camera(s), and/or the like. Four example, four fisheye cameras may be positioned on the vehicle's front, rear, and sides. In an alternative arrangement, the vehicle may use three surround camera(s) 1274 (e.g., left, right, and rear), and may leverage one or more other camera(s) (e.g., a forward-facing camera) as a fourth surround view camera.

Cameras with a field of view that include portions of the environment to the rear of the vehicle 1200 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1298, stereo camera(s) 1268), infrared camera(s) 1272, etc.), as described herein.

Cameras with a field of view that include portions of the interior environment within the cabin of the vehicle 1200 (e.g., one or more OMS sensor(s) 1201) may be used as part of an occupant monitoring system (OMS) such as, but not limited to, a driver monitoring system (DMS). For example, OMS sensors (e.g., the OMS sensor(s) 1201) may be used (e.g., by the controller(s) 1236) to track an occupant's and/or driver's gaze direction, head pose, and/or blinking. This gaze information may be used to determine a level of attentiveness of the occupant or driver (e.g., to detect drowsiness, fatigue, and/or distraction), and/or to take responsive action to prevent harm to the occupant or operator. In some embodiments, data from OMS sensors may be used to allow gaze-controlled operations triggered by driver and/or non-driver occupants such as, but not limited to, adjusting cabin temperature and/or airflow, opening and closing windows, controlling cabin lighting, controlling entertainment systems, adjusting mirrors, adjusting seat positions, and/or other operations. In some embodiments, an OMS may be used for applications such as determining when objects and/or occupants have been left behind in a vehicle cabin (e.g., by detecting occupant presence after the driver exits the vehicle).

FIG. 12C is a block diagram of an example system architecture for the example autonomous vehicle 1200 of FIG. 12A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1200 in FIG. 12C are illustrated as being connected via bus 1202. The bus 1202 may include a Controller Area Network (CAN) data interface (alternatively referred to herein as a “CAN bus”). A CAN may be a network inside the vehicle 1200 used to aid in control of various features and functionality of the vehicle 1200, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1202 is described herein as being a CAN bus, this is not intended to be limiting. For example, in addition to, or alternatively from, the CAN bus, FlexRay and/or Ethernet may be used. Additionally, although a single line is used to represent the bus 1202, this is not intended to be limiting. For example, there may be any number of busses 1202, which may include one or more CAN busses, one or more FlexRay busses, one or more Ethernet busses, and/or one or more other types of busses using a different protocol. In some examples, two or more busses 1202 may be used to perform different functions, and/or may be used for redundancy. For example, a first bus 1202 may be used for collision avoidance functionality and a second bus 1202 may be used for actuation control. In any example, each bus 1202 may communicate with any of the components of the vehicle 1200, and two or more busses 1202 may communicate with the same components. In some examples, each SoC 1204, each controller 1236, and/or each computer within the vehicle may have access to the same input data (e.g., inputs from sensors of the vehicle 1200), and may be connected to a common bus, such the CAN bus.

The vehicle 1200 may include one or more controller(s) 1236, such as those described herein with respect to FIG. 12A. The controller(s) 1236 may be used for a variety of functions. The controller(s) 1236 may be coupled to any of the various other components and systems of the vehicle 1200, and may be used for control of the vehicle 1200, artificial intelligence of the vehicle 1200, infotainment for the vehicle 1200, and/or the like.

The vehicle 1200 may include a system(s) on a chip (SoC) 1204. The SoC 1204 may include CPU(s) 1206, GPU(s) 1208, processor(s) 1210, cache(s) 12, accelerator(s) 1214, data store(s) 1216, and/or other components and features not illustrated. The SoC(s) 1204 may be used to control the vehicle 1200 in a variety of platforms and systems. For example, the SoC(s) 1204 may be combined in a system (e.g., the system of the vehicle 1200) with an HD map 1222 which may obtain map refreshes and/or updates via a network interface 1224 from one or more servers (e.g., server(s) 1278 of FIG. 12D).

The CPU(s) 1206 may include a CPU cluster or CPU complex (alternatively referred to herein as a “CCPLEX”). The CPU(s) 1206 may include multiple cores and/or L2 caches. For example, in some embodiments, the CPU(s) 1206 may include eight cores in a coherent multi-processor configuration. In some embodiments, the CPU(s) 1206 may include four dual-core clusters where each cluster has a dedicated L2 cache (e.g., a 2 MB L2 cache). The CPU(s) 1206 (e.g., the CCPLEX) may be configured to support simultaneous cluster operation allowing any combination of the clusters of the CPU(s) 1206 to be active at any given time.

The CPU(s) 1206 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1206 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1208 may include an integrated GPU (alternatively referred to herein as an “iGPU”). The GPU(s) 1208 may be programmable and may be efficient for parallel workloads. The GPU(s) 1208, in some examples, may use an enhanced tensor instruction set. The GPU(s) 1208 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1208 may include at least eight streaming microprocessors. The GPU(s) 1208 may use compute application programming interface(s) (API(s)). In addition, the GPU(s) 1208 may use one or more parallel computing platforms and/or programming models (e.g., NVIDIA's CUDA).

The GPU(s) 1208 may be power-optimized for best performance in automotive and embedded use cases. For example, the GPU(s) 1208 may be fabricated on a Fin field-effect transistor (FinFET). However, this is not intended to be limiting and the GPU(s) 1208 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to allow finer-grain synchronization and cooperation between parallel threads. The streaming microprocessors may include a combined L1 data cache and shared memory unit in order to improve performance while simplifying programming.

The GPU(s) 1208 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1208 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1208 to access the CPU(s) 1206 page tables directly. In such examples, when the GPU(s) 1208 memory management unit (MMU) experiences a miss, an address translation request may be transmitted to the CPU(s) 1206. In response, the CPU(s) 1206 may look in its page tables for the virtual-to-physical mapping for the address and transmits the translation back to the GPU(s) 1208. As such, unified memory technology may allow a single unified virtual address space for memory of both the CPU(s) 1206 and the GPU(s) 1208, thereby simplifying the GPU(s) 1208 programming and porting of applications to the GPU(s) 1208.

In addition, the GPU(s) 1208 may include an access counter that may keep track of the frequency of access of the GPU(s) 1208 to memory of other processors. The access counter may help ensure that memory pages are moved to the physical memory of the processor that is accessing the pages most frequently.

The SoC(s) 1204 may include any number of cache(s) 12, including those described herein. For example, the cache(s) 12 may include an L3 cache that is available to both the CPU(s) 1206 and the GPU(s) 1208 (e.g., that is connected both the CPU(s) 1206 and the GPU(s) 1208). The cache(s) 12 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1204 may include an arithmetic logic unit(s) (ALU(s)) which may be leveraged in performing processing with respect to any of the variety of tasks or operations of the vehicle 1200—such as processing DNNs. In addition, the SoC(s) 1204 may include a floating point unit(s) (FPU(s))—or other math coprocessor or numeric coprocessor types—for performing mathematical operations within the system. For example, the SoC(s) 1204 may include one or more FPUs integrated as execution units within a CPU(s) 1206 and/or GPU(s) 1208.

The SoC(s) 1204 may include one or more accelerators 1214 (e.g., hardware accelerators, software accelerators, or a combination thereof). For example, the SoC(s) 1204 may include a hardware acceleration cluster that may include optimized hardware accelerators and/or large on-chip memory. The large on-chip memory (e.g., 4 MB of SRAM), may allow the hardware acceleration cluster to accelerate neural networks and other calculations. The hardware acceleration cluster may be used to complement the GPU(s) 1208 and to off-load some of the tasks of the GPU(s) 1208 (e.g., to free up more cycles of the GPU(s) 1208 for performing other tasks). As an example, the accelerator(s) 1214 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1214 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1208, and by using an inference accelerator, for example, a designer may target either the DLA(s) or the GPU(s) 1208 for any function. For example, the designer may focus processing of CNNs and floating point operations on the DLA(s) and leave other functions to the GPU(s) 1208 and/or other accelerator(s) 1214.

The accelerator(s) 1214 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may allow components of the PVA(s) to access the system memory independently of the CPU(s) 1206. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1214 (e.g., the hardware acceleration cluster) may include a computer vision network on-chip and SRAM, for providing a high-bandwidth, low latency SRAM for the accelerator(s) 1214. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1204 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LiDAR data for purposes of localization and/or other functions, and/or for other uses. In some embodiments, one or more tree traversal units (TTUs) may be used for executing one or more ray-tracing related operations.

The accelerator(s) 1214 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. As such, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1266 output that correlates with the vehicle 1200 orientation, distance, 3D location estimates of the object obtained from the neural network and/or other sensors (e.g., LiDAR sensor(s) 1264 or RADAR sensor(s) 1260), among others.

The SoC(s) 1204 may include data store(s) 1216 (e.g., memory). The data store(s) 1216 may be on-chip memory of the SoC(s) 1204, which may store neural networks to be executed on the GPU and/or the DLA. In some examples, the data store(s) 1216 may be large enough in capacity to store multiple instances of neural networks for redundancy and safety. The data store(s) 1216 may comprise L2 or L3 cache(s) 12. Reference to the data store(s) 1216 may include reference to the memory associated with the PVA, DLA, and/or other accelerator(s) 1214, as described herein.

The SoC(s) 1204 may include one or more processor(s) 1210 (e.g., embedded processors). The processor(s) 1210 may include a boot and power management processor that may be a dedicated processor and subsystem to handle boot power and management functions and related security enforcement. The boot and power management processor may be a part of the SoC(s) 1204 boot sequence and may provide runtime power management services. The boot power and management processor may provide clock and voltage programming, assistance in system low power state transitions, management of SoC(s) 1204 thermals and temperature sensors, and/or management of the SoC(s) 1204 power states. Each temperature sensor may be implemented as a ring-oscillator whose output frequency is proportional to temperature, and the SoC(s) 1204 may use the ring-oscillators to detect temperatures of the CPU(s) 1206, GPU(s) 1208, and/or accelerator(s) 1214. If temperatures are determined to exceed a threshold, the boot and power management processor may enter a temperature fault routine and put the SoC(s) 1204 into a lower power state and/or put the vehicle 1200 into a chauffeur to safe stop mode (e.g., bring the vehicle 1200 to a safe stop).

The processor(s) 1210 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1210 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1210 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1210 may further include a real-time camera engine that may include a dedicated processor subsystem for handling real-time camera management.

The processor(s) 1210 may further include a high-dynamic range signal processor that may include an image signal processor that is a hardware engine that is part of the camera processing pipeline.

The processor(s) 1210 may include a video image compositor that may be a processing block (e.g., implemented on a microprocessor) that implements video post-processing functions needed by a video playback application to produce the final image for the player window. The video image compositor may perform lens distortion correction on wide-view camera(s) 1270, surround camera(s) 1274, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1208 is not required to continuously render new surfaces. Even when the GPU(s) 1208 is powered on and active doing 3D rendering, the video image compositor may be used to offload the GPU(s) 1208 to improve performance and responsiveness.

The SoC(s) 1204 may further include a mobile industry processor interface (MIPI) camera serial interface for receiving video and input from cameras, a high-speed interface, and/or a video input block that may be used for camera and related pixel input functions. The SoC(s) 1204 may further include an input/output controller(s) that may be controlled by software and may be used for receiving I/O signals that are uncommitted to a specific role.

The SoC(s) 1204 may further include a broad range of peripheral interfaces to allow communication with peripherals, audio codecs, power management, and/or other devices. The SoC(s) 1204 may be used to process data from cameras (e.g., connected over Gigabit Multimedia Serial Link and Ethernet), sensors (e.g., LiDAR sensor(s) 1264, RADAR sensor(s) 1260, etc. that may be connected over Ethernet), data from bus 1202 (e.g., speed of vehicle 1200, steering wheel position, etc.), data from GNSS sensor(s) 1258 (e.g., connected over Ethernet or CAN bus). The SoC(s) 1204 may further include dedicated high-performance mass storage controllers that may include their own DMA engines, and that may be used to free the CPU(s) 1206 from routine data management tasks.

The SoC(s) 1204 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1204 may be faster, more reliable, and even more energy-efficient and space-efficient than conventional systems. For example, the accelerator(s) 1214, when combined with the CPU(s) 1206, the GPU(s) 1208, and the data store(s) 1216, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to allow Level 3-5 autonomous driving functionality. For example, a CNN executing on the DLA or dGPU (e.g., the GPU(s) 1220) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1208.

In some examples, a CNN for facial recognition and vehicle owner identification may use data from camera sensors to identify the presence of an authorized driver and/or owner of the vehicle 1200. The always on sensor processing engine may be used to unlock the vehicle when the owner approaches the driver door and turn on the lights, and, in security mode, to disable the vehicle when the owner leaves the vehicle. In this way, the SoC(s) 1204 provide for security against theft and/or carjacking.

In another example, a CNN for emergency vehicle detection and identification may use data from microphones 1296 to detect and identify emergency vehicle sirens. In contrast to conventional systems, that use general classifiers to detect sirens and manually extract features, the SoC(s) 1204 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1258. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1262, until the emergency vehicle(s) passes.

The vehicle may include a CPU(s) 1218 (e.g., discrete CPU(s), or dCPU(s)), that may be coupled to the SoC(s) 1204 via a high-speed interconnect (e.g., PCIe). The CPU(s) 1218 may include an X86 processor, for example. The CPU(s) 1218 may be used to perform any of a variety of functions, including arbitrating potentially inconsistent results between ADAS sensors and the SoC(s) 1204, and/or monitoring the status and health of the controller(s) 1236 and/or infotainment SoC 1230, for example.

The vehicle 1200 may include a GPU(s) 1220 (e.g., discrete GPU(s), or dGPU(s)), that may be coupled to the SoC(s) 1204 via a high-speed interconnect (e.g., NVIDIA's NVLINK). The GPU(s) 1220 may provide additional artificial intelligence functionality, such as by executing redundant and/or different neural networks, and may be used to train and/or update neural networks based on input (e.g., sensor data) from sensors of the vehicle 1200.

The vehicle 1200 may further include the network interface 1224 which may include one or more wireless antennas 1226 (e.g., one or more wireless antennas for different communication protocols, such as a cellular antenna, a Bluetooth antenna, etc.). The network interface 1224 may be used to allow wireless connectivity over the Internet with the cloud (e.g., with the server(s) 1278 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1200 information about vehicles in proximity to the vehicle 1200 (e.g., vehicles in front of, on the side of, and/or behind the vehicle 1200). This functionality may be part of a cooperative adaptive cruise control functionality of the vehicle 1200.

The network interface 1224 may include a SoC that provides modulation and demodulation functionality and enables the controller(s) 1236 to communicate over wireless networks. The network interface 1224 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1200 may further include data store(s) 1228 which may include off-chip (e.g., off the SoC(s) 1204) storage. The data store(s) 1228 may include one or more storage elements including RAM, SRAM, DRAM, VRAM, Flash, hard disks, and/or other components and/or devices that may store at least one bit of data.

The vehicle 1200 may further include GNSS sensor(s) 1258. The GNSS sensor(s) 1258 (e.g., GPS, assisted GPS sensors, differential GPS (DGPS) sensors, etc.), to assist in mapping, perception, occupancy grid generation, and/or path planning functions. Any number of GNSS sensor(s) 1258 may be used, including, for example and without limitation, a GPS using a USB connector with an Ethernet to Serial (RS-232) bridge.

The vehicle 1200 may further include RADAR sensor(s) 1260. The RADAR sensor(s) 1260 may be used by the vehicle 1200 for long-range vehicle detection, even in darkness and/or severe weather conditions. RADAR functional safety levels may be ASIL B. The RADAR sensor(s) 1260 may use the CAN and/or the bus 1202 (e.g., to transmit data generated using the RADAR sensor(s) 1260) for control and to access object tracking data, with access to Ethernet to access raw data in some examples. A wide variety of RADAR sensor types may be used. For example, and without limitation, the RADAR sensor(s) 1260 may be suitable for front, rear, and side RADAR use. In some example, Pulse Doppler RADAR sensor(s) are used.

The RADAR sensor(s) 1260 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1260 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1200 surroundings at higher speeds with minimal interference from traffic in adjacent lanes. The other two antennae may expand the field of view, making it possible to quickly detect vehicles entering or leaving the vehicle's 1200 lane.

Mid-range RADAR systems may include, as an example, a range of up to 1260 m (front) or 80 m (rear), and a field of view of up to 42 degrees (front) or 1250 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1200 may further include ultrasonic sensor(s) 1262. The ultrasonic sensor(s) 1262, which may be positioned at the front, back, and/or the sides of the vehicle 1200, may be used for park assist and/or to create and update an occupancy grid. A wide variety of ultrasonic sensor(s) 1262 may be used, and different ultrasonic sensor(s) 1262 may be used for different ranges of detection (e.g., 2.5 m, 4 m). The ultrasonic sensor(s) 1262 may operate at functional safety levels of ASIL B.

The vehicle 1200 may include LiDAR sensor(s) 1264. The LiDAR sensor(s) 1264 may be used for object and pedestrian detection, emergency braking, collision avoidance, and/or other functions. The LiDAR sensor(s) 1264 may be functional safety level ASIL B. In some examples, the vehicle 1200 may include multiple LiDAR sensors 1264 (e.g., two, four, six, etc.) that may use Ethernet (e.g., to provide data to a Gigabit Ethernet switch).

In some examples, the LiDAR sensor(s) 1264 may be capable of providing a list of objects and their distances for a 360-degree field of view. Commercially available LiDAR sensor(s) 1264 may have an advertised range of approximately 1200 m, with an accuracy of 2 cm-3 cm, and with support for a 1200 Mbps Ethernet connection, for example. In some examples, one or more non-protruding LiDAR sensors 1264 may be used. In such examples, the LiDAR sensor(s) 1264 may be implemented as a small device that may be embedded into the front, rear, sides, and/or corners of the vehicle 1200. The LiDAR sensor(s) 1264, in such examples, may provide up to a 120-degree horizontal and 35-degree vertical field-of-view, with a 200 m range even for low-reflectivity objects. Front-mounted LiDAR sensor(s) 1264 may be configured for a horizontal field of view between 45 degrees and 135 degrees.

In some examples, LiDAR technologies, such as 3D flash LiDAR, may also be used. 3D Flash LiDAR uses a flash of a laser as a transmission source, to illuminate vehicle surroundings up to approximately 200 m. A flash LiDAR unit includes a receptor, which records the laser pulse transit time and the reflected light on each pixel, which in turn corresponds to the range from the vehicle to the objects. Flash LiDAR may allow for highly accurate and distortion-free images of the surroundings to be generated with every laser flash. In some examples, four flash LiDAR sensors may be deployed, one at each side of the vehicle 1200. Available 3D flash LiDAR systems include a solid-state 3D staring array LiDAR camera with no moving parts other than a fan (e.g., a non-scanning LiDAR device). The flash LiDAR device may use a 5 nanosecond class I (eye-safe) laser pulse per frame and may capture the reflected laser light in the form of 3D range point clouds and co-registered intensity data. By using flash LiDAR, and because flash LiDAR is a solid-state device with no moving parts, the LiDAR sensor(s) 1264 may be less susceptible to motion blur, vibration, and/or shock.

The vehicle may further include IMU sensor(s) 1266. The IMU sensor(s) 1266 may be located at a center of the rear axle of the vehicle 1200, in some examples. The IMU sensor(s) 1266 may include, for example and without limitation, an accelerometer(s), a magnetometer(s), a gyroscope(s), a magnetic compass(es), and/or other sensor types. In some examples, such as in six-axis applications, the IMU sensor(s) 1266 may include accelerometers and gyroscopes, while in nine-axis applications, the IMU sensor(s) 1266 may include accelerometers, gyroscopes, and magnetometers.

In some embodiments, the IMU sensor(s) 1266 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1266 may allow the vehicle 1200 to estimate heading without requiring input from a magnetic sensor by directly observing and correlating the changes in velocity from GPS to the IMU sensor(s) 1266. In some examples, the IMU sensor(s) 1266 and the GNSS sensor(s) 1258 may be combined in a single integrated unit.

The vehicle may include microphone(s) 1296 placed in and/or around the vehicle 1200. The microphone(s) 1296 may be used for emergency vehicle detection and identification, among other things.

The vehicle may further include any number of camera types, including stereo camera(s) 1268, wide-view camera(s) 1270, infrared camera(s) 1272, surround camera(s) 1274, long-range and/or mid-range camera(s) 1298, and/or other camera types. The cameras may be used to capture image data around an entire periphery of the vehicle 1200. The types of cameras used depends on the embodiments and requirements for the vehicle 1200, and any combination of camera types may be used to provide the necessary coverage around the vehicle 1200. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 12A and FIG. 12B.

The vehicle 1200 may further include vibration sensor(s) 1242. The vibration sensor(s) 1242 may measure vibrations of components of the vehicle, such as the axle(s). For example, changes in vibrations may indicate a change in road surfaces. In another example, when two or more vibration sensors 1242 are used, the differences between the vibrations may be used to determine friction or slippage of the road surface (e.g., when the difference in vibration is between a power-driven axle and a freely rotating axle).

The vehicle 1200 may include an ADAS system 1238. The ADAS system 1238 may include a SoC, in some examples. The ADAS system 1238 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1260, LiDAR sensor(s) 1264, and/or a camera(s). The ACC systems may include longitudinal ACC and/or lateral ACC. Longitudinal ACC monitors and controls the distance to the vehicle immediately ahead of the vehicle 1200 and automatically adjust the vehicle speed to maintain a safe distance from vehicles ahead. Lateral ACC performs distance keeping, and advises the vehicle 1200 to change lanes when necessary. Lateral ACC is related to other ADAS applications such as LCA and CWS.

CACC uses information from other vehicles that may be received via the network interface 1224 and/or the wireless antenna(s) 1226 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1200), while the I2V communication concept provides information about traffic further ahead. CACC systems may include either or both I2V and V2V information sources. Given the information of the vehicles ahead of the vehicle 1200, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1260, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1260, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1200 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1200 if the vehicle 1200 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1260, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1200 is backing up. Some RCTW systems include AEB to ensure that the vehicle brakes are applied to avoid a crash. RCTW systems may use one or more rear-facing RADAR sensor(s) 1260, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1200, the vehicle 1200 itself must, in the case of conflicting results, decide whether to heed the result from a primary computer or a secondary computer (e.g., a first controller 1236 or a second controller 1236). For example, in some embodiments, the ADAS system 1238 may be a backup and/or secondary computer for providing perception information to a backup computer rationality module. The backup computer rationality monitor may run a redundant diverse software on hardware components to detect faults in perception and dynamic driving tasks. Outputs from the ADAS system 1238 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1204.

In other examples, ADAS system 1238 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1238 may be fed into the primary computer's perception block and/or the primary computer's dynamic driving task block. For example, if the ADAS system 1238 indicates a forward crash warning due to an object immediately ahead, the perception block may use this information when identifying objects. In other examples, the secondary computer may have its own neural network which is trained and thus reduces the risk of false positives, as described herein.

The vehicle 1200 may further include the infotainment SoC 1230 (e.g., an in-vehicle infotainment system (IVI)). Although illustrated and described as a SoC, the infotainment system may not be a SoC, and may include two or more discrete components. The infotainment SoC 1230 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1200. For example, the infotainment SoC 1230 may radios, disk players, navigation systems, video players, USB and Bluetooth connectivity, carputers, in-car entertainment, Wi-Fi, steering wheel audio controls, hands free voice control, a heads-up display (HUD), an HMI display 1234, a telematics device, a control panel (e.g., for controlling and/or interacting with various components, features, and/or systems), and/or other components. The infotainment SoC 1230 may further be used to provide information (e.g., visual and/or audible) to a user(s) of the vehicle, such as information from the ADAS system 1238, autonomous driving information such as planned vehicle maneuvers, trajectories, surrounding environment information (e.g., intersection information, vehicle information, road information, etc.), and/or other information.

The infotainment SoC 1230 may include GPU functionality. The infotainment SoC 1230 may communicate over the bus 1202 (e.g., CAN bus, Ethernet, etc.) with other devices, systems, and/or components of the vehicle 1200. In some examples, the infotainment SoC 1230 may be coupled to a supervisory MCU such that the GPU of the infotainment system may perform some self-driving functions in the event that the primary controller(s) 1236 (e.g., the primary and/or backup computers of the vehicle 1200) fail. In such an example, the infotainment SoC 1230 may put the vehicle 1200 into a chauffeur to safe stop mode, as described herein.

The vehicle 1200 may further include an instrument cluster 1232 (e.g., a digital dash, an electronic instrument cluster, a digital instrument panel, etc.). The instrument cluster 1232 may include a controller and/or supercomputer (e.g., a discrete controller or supercomputer). The instrument cluster 1232 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1230 and the instrument cluster 1232. As such, the instrument cluster 1232 may be included as part of the infotainment SoC 1230, or vice versa.

FIG. 12D is a system diagram for communication between cloud-based server(s) and the example autonomous vehicle 1200 of FIG. 12A, in accordance with some embodiments of the present disclosure. The system 1276 may include server(s) 1278, network(s) 1290, and vehicles, including the vehicle 1200. The server(s) 1278 may include a plurality of GPUs 1284(A)-1284(H) (collectively referred to herein as GPUs 1284), PCIe switches 1282(A)-1282(D) (collectively referred to herein as PCIe switches 1282), and/or CPUs 1280(A)-1280(B) (collectively referred to herein as CPUs 1280). The GPUs 1284, the CPUs 1280, and the PCIe switches may be interconnected with high-speed interconnects such as, for example and without limitation, NVLink interfaces 1288 developed by NVIDIA and/or PCIe connections 1286. In some examples, the GPUs 1284 are connected via NVLink and/or NVSwitch SoC and the GPUs 1284 and the PCIe switches 1282 are connected via PCIe interconnects. Although eight GPUs 1284, two CPUs 1280, and two PCIe switches are illustrated, this is not intended to be limiting. Depending on the embodiment, each of the server(s) 1278 may include any number of GPUs 1284, CPUs 1280, and/or PCIe switches. For example, the server(s) 1278 may each include eight, sixteen, thirty-two, and/or more GPUs 1284.

The server(s) 1278 may receive, over the network(s) 1290 and from the vehicles, image data representative of images showing unexpected or changed road conditions, such as recently commenced road-work. The server(s) 1278 may transmit, over the network(s) 1290 and to the vehicles, neural networks 1292, updated neural networks 1292, and/or map information 1294, including information regarding traffic and road conditions. The updates to the map information 1294 may include updates for the HD map 1222, such as information regarding construction sites, potholes, detours, flooding, and/or other obstructions. In some examples, the neural networks 1292, the updated neural networks 1292, and/or the map information 1294 may have resulted from new training and/or experiences represented in data received from any number of vehicles in the environment, and/or based on training performed at a datacenter (e.g., using the server(s) 1278 and/or other servers).

The server(s) 1278 may be used to train machine learning models (e.g., neural networks) based on training data. The training data may be generated using the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1290, and/or the machine learning models may be used by the server(s) 1278 to remotely monitor the vehicles.

In some examples, the server(s) 1278 may receive data from the vehicles and apply the data to up-to-date real-time neural networks for real-time intelligent inferencing. The server(s) 1278 may include deep-learning supercomputers and/or dedicated AI computers powered by GPU(s) 1284, such as a DGX and DGX Station machines developed by NVIDIA. However, in some examples, the server(s) 1278 may include deep learning infrastructure that use only CPU-powered datacenters.

The deep-learning infrastructure of the server(s) 1278 may be capable of fast, real-time inferencing, and may use that capability to evaluate and verify the health of the processors, software, and/or associated hardware in the vehicle 1200. For example, the deep-learning infrastructure may receive periodic updates from the vehicle 1200, such as a sequence of images and/or objects that the vehicle 1200 has located in that sequence of images (e.g., via computer vision and/or other machine learning object classification techniques). The deep-learning infrastructure may run its own neural network to identify the objects and compare them with the objects identified by the vehicle 1200 and, if the results do not match and the infrastructure concludes that the AI in the vehicle 1200 is malfunctioning, the server(s) 1278 may transmit a signal to the vehicle 1200 instructing a fail-safe computer of the vehicle 1200 to assume control, notify the passengers, and complete a safe parking maneuver.

For inferencing, the server(s) 1278 may include the GPU(s) 1284 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 13 is a block diagram of an example computing device(s) 1300 suitable for use in implementing some embodiments of the present disclosure. Computing device 1300 may include an interconnect system 1302 that directly or indirectly couples the following devices: memory 1304, one or more central processing units (CPUs) 1306, one or more graphics processing units (GPUs) 1308, a communication interface 1310, input/output (I/O) ports 1312, input/output components 1314, a power supply 1316, one or more presentation components 1318 (e.g., display(s)), and one or more logic units 1320. In at least one embodiment, the computing device(s) 1300 may comprise one or more virtual machines (VMs), and/or any of the components thereof may comprise virtual components (e.g., virtual hardware components). For non-limiting examples, one or more of the GPUs 1308 may comprise one or more vGPUs, one or more of the CPUs 1306 may comprise one or more vCPUs, and/or one or more of the logic units 1320 may comprise one or more virtual logic units. As such, a computing device(s) 1300 may include discrete components (e.g., a full GPU dedicated to the computing device 1300), virtual components (e.g., a portion of a GPU dedicated to the computing device 1300), or a combination thereof.

Although the various blocks of FIG. 13 are shown as connected via the interconnect system 1302 with lines, this is not intended to be limiting and is for clarity only. For example, in some embodiments, a presentation component 1318, such as a display device, may be considered an I/O component 1314 (e.g., if the display is a touch screen). As another example, the CPUs 1306 and/or GPUs 1308 may include memory (e.g., the memory 1304 may be representative of a storage device in addition to the memory of the GPUs 1308, the CPUs 1306, and/or other components). As such, the computing device of FIG. 13 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 13.

The interconnect system 1302 may represent one or more links or busses, such as an address bus, a data bus, a control bus, or a combination thereof. The interconnect system 1302 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1306 may be directly connected to the memory 1304. Further, the CPU 1306 may be directly connected to the GPU 1308. Where there is direct, or point-to-point connection between components, the interconnect system 1302 may include a PCIe link to carry out the connection. In these examples, a PCI bus need not be included in the computing device 1300.

The memory 1304 may include any of a variety of computer-readable media. The computer-readable media may be any available media that may be accessed by the computing device 1300. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1304 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1300. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1306 may be configured to execute at least some of the computer-readable instructions to control one or more components of the computing device 1300 to perform one or more of the methods and/or processes described herein. The CPU(s) 1306 may each include one or more cores (e.g., one, two, four, eight, twenty-eight, seventy-two, etc.) that are capable of handling a multitude of software threads simultaneously. The CPU(s) 1306 may include any type of processor, and may include different types of processors depending on the type of computing device 1300 implemented (e.g., processors with fewer cores for mobile devices and processors with more cores for servers). For example, depending on the type of computing device 1300, the processor may be an Advanced RISC Machines (ARM) processor implemented using Reduced Instruction Set Computing (RISC) or an x86 processor implemented using Complex Instruction Set Computing (CISC). The computing device 1300 may include one or more CPUs 1306 in addition to one or more microprocessors or supplementary co-processors, such as math co-processors.

In addition to or alternatively from the CPU(s) 1306, the GPU(s) 1308 may be configured to execute at least some of the computer-readable instructions to control one or more components of the computing device 1300 to perform one or more of the methods and/or processes described herein. One or more of the GPU(s) 1308 may be an integrated GPU (e.g., with one or more of the CPU(s) 1306 and/or one or more of the GPU(s) 1308 may be a discrete GPU. In embodiments, one or more of the GPU(s) 1308 may be a coprocessor of one or more of the CPU(s) 1306. The GPU(s) 1308 may be used by the computing device 1300 to render graphics (e.g., 3D graphics) or perform general purpose computations. For example, the GPU(s) 1308 may be used for General-Purpose computing on GPUs (GPGPU). The GPU(s) 1308 may include hundreds or thousands of cores that are capable of handling hundreds or thousands of software threads simultaneously. The GPU(s) 1308 may generate pixel data for output images in response to rendering commands (e.g., rendering commands from the CPU(s) 1306 received via a host interface). The GPU(s) 1308 may include graphics memory, such as display memory, for storing pixel data or any other suitable data, such as GPGPU data. The display memory may be included as part of the memory 1304. The GPU(s) 1308 may include two or more GPUs operating in parallel (e.g., via a link). The link may directly connect the GPUs (e.g., using NVLINK) or may connect the GPUs through a switch (e.g., using NVSwitch). When combined together, each GPU 1308 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1306 and/or the GPU(s) 1308, the logic unit(s) 1320 may be configured to execute at least some of the computer-readable instructions to control one or more components of the computing device 1300 to perform one or more of the methods and/or processes described herein. In embodiments, the CPU(s) 1306, the GPU(s) 1308, and/or the logic unit(s) 1320 may discretely or jointly perform any combination of the methods, processes and/or portions thereof. One or more of the logic units 1320 may be part of and/or integrated in one or more of the CPU(s) 1306 and/or the GPU(s) 1308 and/or one or more of the logic units 1320 may be discrete components or otherwise external to the CPU(s) 1306 and/or the GPU(s) 1308. In embodiments, one or more of the logic units 1320 may be a coprocessor of one or more of the CPU(s) 1306 and/or one or more of the GPU(s) 1308.

Examples of the logic unit(s) 1320 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1310 may include one or more receivers, transmitters, and/or transceivers that allow the computing device 1300 to communicate with other computing devices via an electronic communication network, included wired and/or wireless communications. The communication interface 1310 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1320 and/or communication interface 1310 may include one or more data processing units (DPUs) to transmit data received over a network and/or through interconnect system 1302 directly to (e.g., a memory of) one or more GPU(s) 1308.

The I/O ports 1312 may allow the computing device 1300 to be logically coupled to other devices including the I/O components 1314, the presentation component(s) 1318, and/or other components, some of which may be built in to (e.g., integrated in) the computing device 1300. Illustrative I/O components 1314 include a microphone, mouse, keyboard, joystick, game pad, game controller, satellite dish, scanner, printer, wireless device, etc. The I/O components 1314 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1300. The computing device 1300 may be include depth cameras, such as stereoscopic camera systems, infrared camera systems, RGB camera systems, touchscreen technology, and combinations of these, for gesture detection and recognition. Additionally, the computing device 1300 may include accelerometers or gyroscopes (e.g., as part of an inertia measurement unit (IMU)) that allow detection of motion. In some examples, the output of the accelerometers or gyroscopes may be used by the computing device 1300 to render immersive augmented reality or virtual reality.

The power supply 1316 may include a hard-wired power supply, a battery power supply, or a combination thereof. The power supply 1316 may provide power to the computing device 1300 to allow the components of the computing device 1300 to operate.

The presentation component(s) 1318 may include a display (e.g., a monitor, a touch screen, a television screen, a heads-up-display (HUD), other display types, or a combination thereof), speakers, and/or other presentation components. The presentation component(s) 1318 may receive data from other components (e.g., the GPU(s) 1308, the CPU(s) 1306, DPUs, etc.), and output the data (e.g., as an image, video, sound, etc.).

### Example Data Center

FIG. 14 illustrates an example data center 1400 that may be used in at least one embodiments of the present disclosure. The data center 1400 may include a data center infrastructure layer 1410, a framework layer 1420, a software layer 1430, and/or an application layer 1440.

As shown in FIG. 14, the data center infrastructure layer 1410 may include a resource orchestrator 1412, grouped computing resources 1414, and node computing resources (“node C.R.s”) 1416(1)-1416(N), where “N” represents any whole, positive integer. In at least one embodiment, node C.R.s 1416(1)-1416(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1416(1)-1416(N) may correspond to a server having one or more of the above-mentioned computing resources. In addition, in some embodiments, the node C.R.s 1416(1)-14161 (N) may include one or more virtual components, such as vGPUs, vCPUs, and/or the like, and/or one or more of the node C.R.s 1416(1)-1416(N) may correspond to a virtual machine (VM).

In at least one embodiment, grouped computing resources 1414 may include separate groupings of node C.R.s 1416 housed within one or more racks (not shown), or many racks housed in data centers at various geographical locations (also not shown). Separate groupings of node C.R.s 1416 within grouped computing resources 1414 may include grouped compute, network, memory or storage resources that may be configured or allocated to support one or more workloads. In at least one embodiment, several node C.R.s 1416 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1412 may configure or otherwise control one or more node C.R.s 1416(1)-1416(N) and/or grouped computing resources 1414. In at least one embodiment, resource orchestrator 1412 may include a software design infrastructure (SDI) management entity for the data center 1400. The resource orchestrator 1412 may include hardware, software, or some combination thereof.

In at least one embodiment, as shown in FIG. 14, framework layer 1420 may include a job scheduler 1433, a configuration manager 1434, a resource manager 1436, and/or a distributed file system 1438. The framework layer 1420 may include a framework to support software 1432 of software layer 1430 and/or one or more application(s) 1442 of application layer 1440. The software 1432 or application(s) 1442 may respectively include web-based service software or applications, such as those provided by Amazon Web Services, Google Cloud and Microsoft Azure. The framework layer 1420 may be, but is not limited to, a type of free and open-source software web application framework such as Apache Spark™ (hereinafter “Spark”) that may use distributed file system 1438 for large-scale data processing (e.g., “big data”). In at least one embodiment, job scheduler 1433 may include a Spark driver to facilitate scheduling of workloads supported by various layers of data center 1400. The configuration manager 1434 may be capable of configuring different layers such as software layer 1430 and framework layer 1420 including Spark and distributed file system 1438 for supporting large-scale data processing. The resource manager 1436 may be capable of managing clustered or grouped computing resources mapped to or allocated for support of distributed file system 1438 and job scheduler 1433. In at least one embodiment, clustered or grouped computing resources may include grouped computing resource 1414 at data center infrastructure layer 1410. The resource manager 1436 may coordinate with resource orchestrator 1412 to manage these mapped or allocated computing resources.

In at least one embodiment, software 1432 included in software layer 1430 may include software used by at least portions of node C.R.s 1416(1)-1416(N), grouped computing resources 1414, and/or distributed file system 1438 of framework layer 1420. One or more types of software may include, but are not limited to, Internet web page search software, e-mail virus scan software, database software, and streaming video content software.

In at least one embodiment, application(s) 1442 included in application layer 1440 may include one or more types of applications used by at least portions of node C.R.s 1416(1)-1416(N), grouped computing resources 1414, and/or distributed file system 1438 of framework layer 1420. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1434, resource manager 1436, and resource orchestrator 1412 may implement any number and type of self-modifying actions based on any amount and type of data acquired in any technically feasible fashion. Self-modifying actions may relieve a data center operator of data center 1400 from making possibly bad configuration decisions and possibly avoiding underutilized and/or poor performing portions of a data center.

The data center 1400 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1400. In at least one embodiment, trained or deployed machine learning models corresponding to one or more neural networks may be used to infer or predict information using resources described above with respect to the data center 1400 by using weight parameters calculated through one or more training techniques, such as but not limited to those described herein.

In at least one embodiment, the data center 1400 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1300 of FIG. 13—e.g., each device may include similar components, features, and/or functionality of the computing device(s) 1300. In addition, where backend devices (e.g., servers, NAS, etc.) are implemented, the backend devices may be included as part of a data center 1400, an example of which is described in more detail herein with respect to FIG. 14.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1300 described herein with respect to FIG. 13. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

In an example embodiment, one or more processors comprising: processing circuitry to: generate, based at least on sensor data generated using one or more sensors of an ego-machine in an environment, a detected three-dimensional (3D) surface topology of the environment; and generate a visualization of the environment based at least on texturizing the detected 3D surface topology using the sensor data.

In some embodiments, the processing circuitry further to estimate depth data based at least on stacked images representing a common time slice from different perspectives, and generate the detected 3D surface topology based at least on the depth data.

In some embodiments, the processing circuitry further to estimate depth data based at least on stacked images representing a common perspective from different time slices from different perspectives, and generate the detected 3D surface topology based at least on the depth data.

In some embodiments, the processing circuitry further to represent the detected 3D surface topology of the environment using a 3D signed distance function.

In some embodiments, the processing circuitry further to represent the detected 3D surface topology of the environment using a 3D signed distance function truncated to a spherical form with a designated radius.

In some embodiments, the processing circuitry further to generate the detected 3D surface topology of the environment based at least on a plurality of depth maps representing overlapping view of the environment.

In some embodiments, the processing circuitry further to detect and fill in one or more holes in the detected 3D surface topology of the environment.

In some embodiments, the processing circuitry further to apply smoothing to the detected 3D surface topology.

In some embodiments, the processing circuitry further to backwards warp the sensor data using depth data represented by the detected 3D surface topology of the environment.

In some embodiments, the processing circuitry further to texturize one or more empty regions of the detected 3D surface topology based at least on applying blurring.

In some embodiments, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using AI; a system incorporating one or more virtual machines (VMs); a system implemented at least partially in a data center; or a system implemented at least partially using cloud computing resources.

In example embodiments, a system comprising one or more processors to generate a visualization of an environment based at least on texturizing a detected three-dimensional (3D) surface topology of the environment with sensor data generated using one or more sensors of an ego-machine in the environment.

In example embodiments, the one or more processors further to represent the detected 3D surface topology of the environment using a 3D signed distance function.

In example embodiments, the one or more processors further to generate the detected 3D surface topology of the environment based at least on a plurality of depth maps representing overlapping view of the environment.

In example embodiments, the one or more processors further to detect and fill in one or more holes in the detected 3D surface topology of the environment.

In example embodiments, the one or more processors further to apply smoothing to the detected 3D surface topology.

In example embodiments, the one or more processors further to backwards warp the sensor data using depth data represented by the detected 3D surface topology of the environment.

In example embodiments, wherein the system is at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using AI; a system incorporating one or more virtual machines (VMs); a system implemented at least partially in a data center; or a system implemented at least partially using cloud computing resources.

In embodiments, the method comprises generating, based at least on image data generated using one or more cameras of an ego-machine in an environment, a detected three dimensional (3D) surface topology of the environment; and generating a visualization of the environment based at least on projecting the image data onto the detected 3D surface topology.

In embodiments, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using AI; a system incorporating one or more virtual machines (VMs); a system implemented at least partially in a data center; or a system implemented at least partially using cloud computing resources.

In an example embodiment, one or more processors comprising: processing circuitry to: generate, based at least on sensor data generated using one or more sensors of an ego-machine in an environment, and based at least on one or more three-dimensional (3D) representations of one or more detected dynamic objects in the environment, a detected 3D surface topology of the environment; and generate a visualization of the environment based at least on texturizing the one or more 3D representations of the one or more detected dynamic objects in the detected 3D surface topology using the sensor data.

In an example embodiment, the processing circuitry further to mask the one or more detected dynamic objects during a first pass of texturizing the detected 3D surface topology.

In an example embodiment, the processing circuitry further to: generate a first detected 3D surface topology of the environment representing a static portion of the environment; and update the first detected 3D surface topology based at least on inserting the one or more 3D representations of the one or more detected dynamic objects into the first detected 3D surface topology.

In an example embodiment, the processing circuitry further to generate the one or more 3D representation of the one or more detected dynamic objects of one or more classes of rigid objects based at least on warping one or more detected depth values of the one or more detected dynamic objects using one or more detected trajectories of the one or more detected dynamic objects.

In an example embodiment, the processing circuitry further to fuse into the detected 3D surface topology at least a first 3D representation of at least a first detected dynamic object of the one or more detected dynamic objects generated based at least on: tracking a trajectory of the first detected dynamic object; identifying one or more detected depth values representing the first detected object in a previous time slice, and warping the one or more detected depth values using the trajectory.

In an example embodiment, the processing circuitry further to generate the one or more 3D representations of the one or more detected dynamic objects of one or more classes of non-rigid objects based at least on inserting, for at least a first detected object of the one or more detected dynamic objects, a 3D representation of a two-dimensional (2D) surface at a location in the detected 3D surface topology corresponding to a detected location of the first detected object in the environment.

In an example embodiment, the processing circuitry further to fuse into the detected 3D surface topology at least a first 3D representation of a flat surface at a location corresponding to a detected centroid of a corresponding one of the one or more detected dynamic objects.

In an example embodiment, wherein the texturizing of the one or more 3D representations of the one or more detected dynamic objects uses a segmented set of the sensor data classified as belonging to the one or more detected dynamic objects.

In an example embodiment, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using AI; a system incorporating one or more virtual machines (VMs); a system implemented at least partially in a data center; or a system implemented at least partially using cloud computing resources.

In embodiments, a system comprising one or more processors to generate a visualization of an environment based at least on texturizing one or more three-dimensional (3D) representations of one or more detected dynamic objects in a detected 3D surface topology of the environment using sensor data generated using one or more sensors of an ego-machine in the environment.

In embodiments, the one or more processors further to mask the one or more detected dynamic objects during a first pass of texturizing the detected 3D surface topology.

In embodiments, the one or more processors further to: generate a first detected 3D surface topology of the environment representing a static portion of the environment; and update the first detected 3D surface topology based at least on inserting the one or more 3D representations of the one or more detected dynamic objects into the first detected 3D surface topology.

In embodiments, the one or more processors further to generate the one or more 3D representation of one or more detected dynamic objects of one or more classes of rigid objects based at least on warping one or more detected depth values of the one or more detected dynamic objects using one or more detected trajectories of the one or more detected dynamic objects.

In embodiments, the one or more processors further to fuse into the detected 3D surface topology at least a first 3D representation of at least a first detected dynamic object of the one or more detected dynamic objects generated based at least on: tracking a trajectory of the first detected dynamic object, identifying one or more detected depth values representing the first detected object in a previous time slice, and warping the one or more detected depth values using the trajectory.

In embodiments, the one or more processors further to generate the one or more 3D representations of the one or more detected dynamic objects of one or more classes of non-rigid objects based at least on inserting, for at least a first detected object of the one or more detected dynamic objects, a 3D representation of a two-dimensional (2D) surface at a location in the detected 3D surface topology corresponding to a detected location of the first detected object in the environment.

In embodiments, the one or more processors further to fuse into the detected 3D surface topology at least a first 3D representation of a flat surface at a location corresponding to a detected centroid of a corresponding one of the one or more detected dynamic objects.

In embodiments, wherein the texturizing of the one or more 3D representations of the one or more detected dynamic objects uses a segmented set of the sensor data classified as belonging to the one or more detected dynamic objects.

In embodiments, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using AI; a system incorporating one or more virtual machines (VMs); a system implemented at least partially in a data center; or a system implemented at least partially using cloud computing resources.

In embodiments, a method comprising: generating, based at least on image data generated using one or more cameras of an ego-machine in an environment, and based at least on one or more three-dimensional (3D) representations of one or more detected dynamic objects in the environment, a detected 3D surface topology of the environment; and generating a visualization of the environment based at least on projecting the image data onto the one or more 3D representations of the one or more detected dynamic objects in the detected 3D surface topology.

In embodiments, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing real-time streaming; a system for generating or presenting one or more of augmented reality content, virtual reality content, or mixed reality content; a system implemented using an edge device; a system implemented using a robot; a system for performing conversational AI operations; a system for generating synthetic data; a system for generating synthetic data using AI; a system incorporating one or more virtual machines (VMs); a system implemented at least partially in a data center; or a system implemented at least partially using cloud computing resources.

What is claimed is:

1. One or more processors comprising:
processing circuitry to:
compute, based at least on sensor data generated using one or more sensors of an ego-machine in an environment, a three-dimensional (3D) surface topology of the environment; and
generate a visualization of the environment based at least on applying a graphical representation to the 3D surface topology using the sensor data.

2. The one or more processors of claim 1, the processing circuitry further to estimate depth data based at least on a plurality of images representing a common time slice from two or more perspectives, and generate the 3D surface topology based at least on the depth data.

3. The one or more processors of claim 1, the processing circuitry further to estimate depth data based at least on two or more images representing a common perspective from different time slices from at least two perspectives, and compute the 3D surface topology based at least on the depth data.

4. The one or more processors of claim 1, the processing circuitry further to represent the 3D surface topology of the environment using a 3D signed distance function.

5. The one or more processors of claim 1, the processing circuitry further to represent the 3D surface topology of the environment using a 3D signed distance function truncated to a spherical form with a designated radius.

6. The one or more processors of claim 1, the processing circuitry further to compute the 3D surface topology of the environment based at least on a plurality of depth maps representing overlapping view of the environment.

7. The one or more processors of claim 1, the processing circuitry further to detect one or more regions of incomplete content in the 3D surface topology of the environment, and to generate graphical data to replace the one or more regions of incomplete content.

8. The one or more processors of claim 1, the processing circuitry further to apply smoothing to the 3D surface topology.

9. The one or more processors of claim 1, the processing circuitry further to warp the sensor data using depth data represented by the 3D surface topology of the environment.

10. The one or more processors of claim 1, the processing circuitry further to apply a graphical representation for one or more regions of incomplete content in the 3D surface topology based at least on applying blurring.

11. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system incorporating one or more virtual machines (VMs);
a system implemented at least partially in a data center; or
a system implemented at least partially using cloud computing resources.

12. A system comprising one or more processors to generate a visualization of an environment by applying a graphical representation to a three-dimensional (3D) surface topology of the environment, the 3D surface topology being computed based at least on sensor data generated using one or more sensors of an ego-machine in the environment.

13. The system of claim 12, the one or more processors further to represent the 3D surface topology of the environment using a 3D signed distance function.

14. The system of claim 12, the one or more processors further to compute the 3D surface topology of the environment based at least on a plurality of depth maps representing two or more overlapping views of the environment.

15. The system of claim 12, the one or more processors further to detect one or more regions of incomplete content in the 3D surface topology of the environment, and to generate graphical data to replace the one or more regions of incomplete content.

16. The system of claim 12, the one or more processors further to apply smoothing to the 3D surface topology.

17. The system of claim 12, the one or more processors further to warp the sensor data using depth data represented by the 3D surface topology of the environment.

18. The system of claim 12, wherein the system is at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system incorporating one or more virtual machines (VMs);
a system implemented at least partially in a data center; or
a system implemented at least partially using cloud computing resources.

19. A method comprising:
computing, based at least on image data generated using one or more cameras of an ego-machine in an environment, a three dimensional (3D) surface topology of the environment; and
generating a visualization of the environment based at least on projecting the image data onto the 3D surface topology.

20. The method of claim 19, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system for generating synthetic data;
a system for generating synthetic data using AI;
a system incorporating one or more virtual machines (VMs);
a system implemented at least partially in a data center; or
a system implemented at least partially using cloud computing resources.
